(19) United States
(12) Patent Application Publication
(10) Pub. No.: US 2020/0371659 A1
(43) Pub. Date: Nov. 26, 2020

(54) PORTABLE TERMINAL HAVING, AT LATERAL SURFACE THEREOF, PRESSURE SENSOR AND TOUCH SENSOR

(71) Applicant: HiDeep Inc., Seongnam-si, Gyeonggi-do (KR)

(72) Inventors: Seyeob KIM, Seongnam-si, Gyeonggi-do (KR); Yunjoung KIM, Seongnam-si, Gyeonggi-do (KR)

(73) Assignee: HiDeep Inc., Seongnam-si, Gyeonggi-do (KR)

(21) Appl. No.: 16/967,956

(22) PCT Filed: Feb. 14, 2019
(86) PCT No.: PCT/KR2019/001816

§ 371 Date: Aug. 6, 2020

(30) Foreign Application Priority Data
Feb. 14, 2018 (KR) 10-2018-0018766
Mar. 23, 2018 (KR) 10-2018-0033674

(51) Int. Cl. G06F 3/041; G06F 3/044

(52) U.S. Cl. CPC G06F 3/04142; G06F 3/04146; G06F 2203/04105; G06F 3/0447; G06F 3/041662

(57) ABSTRACT

A portable terminal according to an embodiment of the present invention includes: a front surface cover; a pressure detecting unit disposed on a side surface part of the portable terminal and configured to detect a touch pressure applied to the side surface part; and a side surface touch detecting unit configured to detect a touch input on to the side surface part of the portable terminal, wherein the side surface part includes a first region and a second region separate from the first region, the pressure detecting unit is disposed in the first region of the side surface part, and at least a portion of the side touch detecting unit is disposed between a lower portion of the front surface cover and the second region.

### TECHNICAL FIELD

The present invention relates to a portable terminal equipped with a pressure sensor and a touch sensor on a side surface thereof, and more particularly, to a portable terminal which is further equipped with a pressure sensor for detecting a touch pressure applied to a side surface of the portable terminal and a touch sensor for detecting a touch position with respect to the side surface of the portable terminal aside from a pressure sensor or a touch sensor provided to the front surface of the portable terminal.

### BACKGROUND ART

Various types of input apparatuses are being used to operate computer systems. For example, input apparatuses, such as buttons, keys, joysticks, and touch screens are being used. Due to easy and simple operations of a touch screen, uses of touch screens are increasing during operations of computing systems.

The touch screen may constitute a touch surface of a touch input apparatus including a touch sensor panel which may be a transparent panel equipped with a touch-sensitive surface. Such a touch input apparatus may be attached to the front surface of a display screen and the touch-sensitive surface may cover a viewable surface of the display screen. A user may be enabled to operate a computer system by simply touching the touch screen with a finger or the like. In general, computing systems may each perform calculation by recognizing a touch and a touch position on a touch screen and analyzing the touch.

Recently, there have appeared touch input apparatuses each capable of detecting not only a touch position due to a touch on a touch screen but also the magnitude of touch pressure.

In particular, a sensor for detecting a touch position and a sensor for detecting a touch pressure are disposed facing the front surface of a portable terminal. However, the touch position sensor and the touch pressure sensor which are disposed on the front surface are suitable to detect the touch position and the touch pressure which are applied to the front surface of the portable terminal, and thus, there has appeared a demand to change the design of the portable terminal so that the position and pressure of the touch applied to a side surface of the portable terminal.

### DISCLOSURE OF THE INVENTION

### Technical Problem

The present invention is derived from the above-mentioned demand, and the purpose of the present invention is to implement a side surface touch sensor and a side surface pressure sensor which are not a front surface touch sensor and not a front surface pressure sensor but separate sensors.

In addition, the purpose of the present invention is to improve the touch position detection sensitivity in such a way that when the frame of a portable terminal is implemented using a metallic material as a whole, the side surface touch sensor provided to a side surface of the portable terminal is configured to be disposed on a non-metallic material portion.

### Technical Solution

A portable terminal according to an embodiment of the present invention includes: a front surface cover; a pressure detecting unit disposed on a side surface part of the portable terminal and configured to detect a touch pressure applied to the side surface part; and a side surface touch detecting unit configured to detect a touch input on to the side surface part of the portable terminal, wherein

the side surface part includes a first region and a second region separate from the first region, the pressure defecting unit is disposed in the first region of the side surface part, and at least a portion of the side surface touch detecting unit is disposed between a lower portion of the front surface cover and the second region.

The first region may be composed of a conductive material and the second region may be composed of a non-conductive material.

The pressure detecting unit may be disposed parallel to the side surface part, and at least a portion of the side surface touch detecting unit may be disposed in a direction orthogonal to the side surface part.

A portable terminal according to an embodiment of the present invention may further include a display unit disposed under the front surface cover, wherein: a first driving electrode and a receiving electrode which detect a touch pressure against the front surface cover may be disposed on the display unit; at least a portion of the side surface touch detecting unit may be composed of a separate second driving electrode different from the first driving electrode; the remainder of the side surface touch detecting part may include the receiving electrode; and a touch input to the side surface part of the portable terminal may be detected by a change in mutual electrostatic capacitance between the second driving electrode and the receiving electrode.

The second driving electrode may be attached to a lower portion of the front surface cover.

The first driving electrode and the second driving electrode may be disposed on a same plane.

The first region of the side surface part may be a side surface part of a middle frame of the portable terminal, and the pressure detecting unit may be disposed in a mounting space of the side surface part of the middle frame or on an inner side surface of the side surface part of the middle frame.

The first region of the side surface part may be a side surface part of a rear surface cover of the portable terminal,

and the pressure detecting unit may be disposed in a mounting space of the side surface part of the rear surface cover or on an Inner side surface of the side surface part of the rear surface cover.

A first side surface, a second side surface facing the first side surface, or the inner side surface which is in the mounting space may be a reference potential layer, and the touch pressure may be detected by a change in electrostatic capacitance due to a change in a distance between the pressure detecting unit and the reference potential layer.

The portable terminal may further include a side surface cover covering the mounting space.

### Advantageous Effects

According to a portable terminal of an embodiment of the present invention, implemented are a separate side surface touch sensor and a separate side surface pressure sensor which are not a front surface touch sensor and a front surface pressure sensor, and thus, the touch position and the touch pressure which are applied to a side surface of the portable terminal may be detected.

In addition, when the frame of a portable terminal is implemented overall using a metallic material, the side surface touch sensor provided to a side surface of the portable terminal is configured to be disposed on a non-metallic material portion, and thus, the touch position detecting sensitivity With respect to the side surface may be improved.

### BRIEF DESCRIPTION OF THE DRAWINGS

FIG. 1 is a block diagram for describing an operation of a portable terminal according to an embodiment of the present invention.

FIGS. 2a and 2bare conceptual views of a portable terminal of the present invention viewed in mutually different directions.

FIGS. 3a and 3bare conceptual views of a portable terminal according to an embodiment of the present invention viewed in mutually different directions.

FIG. 4 is a view for describing a structure having a side surface operating key formed therein in a portable terminal of the present invention.

FIG. 5 is a view for describing a structure having an input detection part formed in a middle frame and at least a portion of side touch detection parts formed on an upper frame of a portable terminal according to an embodiment of the present invention.

FIG. 6 is a view for describing a structure having an input detection part formed on a rear surface cover and at least a portion of side touch detection parts formed on an upper frame of a portable terminal according to an embodiment of the present invention.

FIG. 7 is a view for illustrating an array of a front surface touch detection part and a side surface touch detection part according to an embodiment of the present invention.

FIG. 8 is a view for exemplarily illustrating a schematic structure of an input detection part included in a portable terminal according to an embodiment of the present invention.

FIGS. 9a to 9d are views for illustrating an exemplary operation principle of a pressure sensor included in a portable terminal according to embodiments of the present invention.

FIGS. 10a to 10i are views for describing the arrangement positions and structures of pressure sensors included in a portable terminal according to embodiments of the present invention.

FIGS. 11a to 11c are views for describing other arrangement positions and structures of pressure sensors included in a portable terminal according to embodiments of the present invention.

FIGS. 12a to 12c are views for describing still other arrangement positions and structures of pressure sensors included in a portable terminal according to embodiments of the present invention.

FIGS. 13a to 13f are views for describing yet other arrangement positions and structures of pressure sensors included in a portable terminal according to embodiments of the present invention.

FIGS. 14a to 14f are views for describing yet still other arrangement positions and structures of pressure sensors included in a portable terminal according to embodiments of the present invention.

FIGS. 15a to 15c are views for illustrating a case in which pressure sensors are strain gauges according to embodiments of the present invention.

FIG. 16 illustrates a control block for controlling a touch position, a touch pressure and function execution corresponding thereto in a portable terminal according to an embodiment of the present invention.

FIGS. 17a to 17b are schematic views of a capacitive-type touch detection part and a configuration for the operation thereof included in a portable terminal according to embodiments of the present invention.

### MODE FOR CARRYING OUT THE INVENTION

The detailed description of the present invention to be described later refers to the accompanying drawings which exemplarily illustrates specific embodiments in which the invention may be practiced. These embodiments will be described in sufficient detail to enable those skilled in the art to practice the invention. It is to be understood that various embodiments of the present invention are different from each other but do not need to be mutually exclusive. For example, a specific shape, structure and characteristics which are disclosed in the present invention provided herein may be implemented as other embodiments without departing from the spirit and scope of the present invention in relation to one embodiment. In addition, it is to be understood that the positions or arrangements of individual components in each disclosed embodiment may be modified without departing from the spirit and scope of the invention. In the drawings, similar reference symbols indicate the same or similar function in many aspects.

Hereinafter, a portable terminal according to an exemplary embodiment of the present invention will be described with reference to accompanying drawings. Portable terminals described in this specification may include a portable phone, a smart phone, a laptop computer, a digital broadcasting terminal device, a personal digital assistant. (PDA), a navigation, a slate PC, a tablet DC, an ultrabook, a wearable device, and the like.

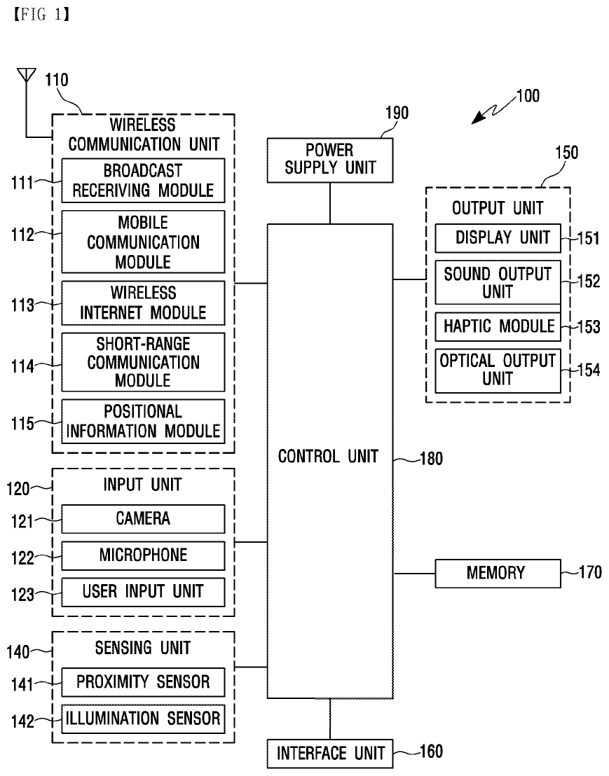

FIG. 1 is a block diagram for describing an operation of a portable terminal according to an embodiment of the present invention and illustrates an example in which the present invention is applied to a smart phone.

Referring to FIG. 1, a portable terminal 100 may include a wireless communication unit 110, an input unit 120, a sensing unit 140, an output unit 150, an interface unit 160, a memory 170, a control unit 180, and a power supply unit 190. The components illustrated in FIG. 1 are not essential in implementing a portable terminal, and the device described in this specification may have components more than or less than the components listed above.

The wireless communication unit 110 may include one or more modules that enable wireless communication between the portable terminal 100 and a wireless communication system, between the portable terminal 100 and another portable terminal, and between the portable terminal 100 and an external server. In addition, the wireless communication unit 110 may include one or more modules that connect the portable terminal 100 to one or more networks. The wireless communication unit 110 may include at least one among a broadcast receiving module 111, a mobile communication module 112, a wireless internet module 113, a short-range communication module 114, or a positional information module 115.

The broadcast receiving module 111 receives broadcasting signals and/or broadcasting related information from an external broadcasting managing server through a broadcasting channel. Here, the broadcasting channel includes a satellite channel, and a ground wave channel, and two or more broadcast receiving modules may be included in the portable terminal 100 for simultaneous broadcasting reception or broadcasting channel switching.

The mobile communication module 112 tranceives wireless signals with at least one among base stations, external terminals, and servers which are built according to technical standards or communication methods for mobile communication. The wireless internet module 113 refers to a module for wireless internet connection, and may be embedded in or externally mounted on the portable terminal 100.

The wireless internet module 113 is configured to tranceive wireless signals in a communication network according to wireless internet techniques such as wireless LAN (WLAN), wireless-fidelity (Wi-Fi) and the like.

The short-range communication module 114 is for supporting short-range communication using techniques such as Bluetooth™, radio frequency identification (RFID), infrared data association (IrDA), ZigBee, near field communication (NFC), or the like.

The positional information module 115 is a module for acquiring the position (or current position) of a device, and representative examples thereof include a global positioning system (GPS) or a wireless fidelity (Wi-Fi) module, but are not limited to a module for directly calculating or acquiring the position of a device.

The input unit 120 may include a camera 121 or an image input unit for inputting image signals, a microphone 122 or an audio input unit for inputting audio signals, a user input unit 123 (for example, a touch key, a mechanical key etc.) for receiving information from a user. The sound data or image data collected from the input unit 120 may be analyzed and processed as user's control command.

The camera 121 processes image frames, such as static images or moving images acquired by an image sensor in a video telephony mode or an imaging mode. The processed image frames may be displayed on the display unit 151 or stored in memories 170.

The microphone 122 processes external audio signals into electrical sound data. The processed sound data may be variously used according to a function (or application program in execution) being executed in the portable terminal 100.

The user input unit 123 is for receiving information from a user, and when information is input through the user input unit 123, the control unit 180 may control the operation of the portable terminal so as to correspond to the input information. Such the user input unit 123 may include a mechanical input means (or, a mechanical key, for example, buttons, a dome switch, a jog wheel, a jog switch, etc. which are positioned on the front/rear surfaces or the side surface of the portable terminal 100) and a touch-type input means. For example, a touch-type input means may be composed of a virtual key, a soft key or a visual key displayed on a touch screen by software processing, or composed of a touch key disposed on a portion other than the touch screen. Here, the touch key may be formed in at least one region of the side surface of the portable terminal 100, such as a power key region, a volume key region, or the like, formed in at least one region among the side surface regions equally divided into two or more regions, or formed in the entire regions of the side surface of the terminal. In addition, the user input unit 123 may include side surface user input units 123a′to 123d′.

The sensing unit 140 may include one or more sensors for sensing at least one among intra-device information, peripheral environmental information surrounding the device, and user information. For example, the sensing unit 140 may include a proximity sensor 141, an illumination sensor 142, a touch sensor, a touch pressure sensor, an acceleration sensor, a magnetic sensor, a G-sensor, a gyroscope sensor, a motion sensor, and the like.

The output unit 150 is for generating an output related to visual, auditory, tactile senses or the like and may at least one among a display unit 151, a sound output unit 152, a haptic module 153, and an optical output unit 154.

The display unit 151 may be composed of, for example, a liquid crystal display (LCD), a thin-film transistor liquid crystal display (TFT-LCD), an organic light-emitting diode (OLED), a flexible display, a three-dimensional (3D) display, an electronic ink (e-ink) display, or the like. The display unit 151 may implement a touch screen by forming a mutual layer structure with a touch sensor or being formed in an integrated type. Such a touch screen may function as the user input unit 123 for providing an input interface between the portable terminal 100 and a user, and simultaneously provide an output interface between the portable terminal 100 and the user.

The display unit 151 may include a touch sensor for detecting a touch with respect to the display unit 151 so as to be capable of receiving a control command by a touch method. When a touch is performed onto the display unit 151 using this, the touch sensor detects the touch and the control unit 180 may be configured to generate a control command corresponding to the touch on the basis of this. The contents input by the touch method may be characters or numerals, or instructions or selectable menu items in various modes. Meanwhile, the touch sensor may be formed in a film shape provided with a touch pattern and disposed between the window and the display on the rear surface of the window, or may be a metal wire directly patterned on the rear surface of the window. According to embodiments, the display unit 151 may be provided with a controller for detecting whether a touch is present or a touch position from a signal detected by the touch sensor. In this case, the controller transmits the detected touch position to the control unit 180. Alternatively, the display unit 151 transmits, to the control unit 180, a signal detected by the touch sensor or data converted into digital data, and may be configured so that the control unit 180 determines the touch presence and a touch position.

The sound output unit 152 is for outputting audio signals such as music or sound and may include a receiver, a speaker, a buzzer, or the like. The haptic module 153 generates various tactile effects sensible by a user. Representative examples of tactile effects generated by the haptic module 153 may be vibrations. The amplitude, pattern, and the like of the vibration generated by the haptic module 153 may be controlled by the selection of a user or setting of the control unit. For example, the haptic module 153 may combine and output mutually different vibrations or sequentially output the vibrations. The haptic module 153 may generate, aside from vibration, various tactile effects such as effects due to stimuli such as pin arrangement vertically moving relative to a contact skin surface, air injection or suction force through an injection port or a suction port, a touch onto a skin surface, a contact with an electrode, or electrostatic force, or effects due to reproduction of cool and hot senses using an element capable of heat absorption or heat generation. The haptic module 153 may also be configured so that not only a tactile effect may be transmitted through a direct contact, but also a user may feel a tactile effect through a muscular sense of a finger, an arm, etc. Two or more haptic modules 153 may be provided according to arrangement mode of the portable terminal 100. The optical output unit 154 outputs a signal for informing occurrence of an event using the light of a light source of the portable terminal 100. Examples of occurred events at the portable terminal 100 may be message reception, call signal reception, absent call, alarm, schedule alarm, email reception, information reception through an application.

The memory 170 stores data for supporting various functions of the portable terminal 100. The memory 170 may store a plurality of application programs or applications driven by the portable terminal 100 and data and commands for operating the portable terminal 100. At least a portion among such application programs may be downloaded from an external server through wireless communication. In addition, at least a portion of such application programs may be present on the portable terminal 100 from the shipment time for the basic functions (for example, call reception, a transmitting function, message reception, and a transmission function). Meanwhile, the application program may be stored in the memory 170, installed on the portable terminal 100, and drive the operation (or function) of the device.

The control unit 180 normally controls, aside from operations related to the applications, overall operations of the portable terminal 100. The control unit 180 may provide or process appropriate information to a user by processing signals, data, information or the like which are input or output through components described above or driving the application programs stored in the memory 170. In addition, the control unit 180 may control at least a portion among the components in order to drive the application programs stored in the memory 170. Furthermore, in order to drive the application programs, the control unit 180 may combine and operate at least two or more among the components included in the portable terminal 100.

The power supply unit 190 receives internal and external power under the control of the control unit 180 and supplies power to the components included in the portable terminal 100. Such the power supply unit 190 may include a battery, and the battery may serve as an embedded battery or a replaceable-type battery.

At least some of the aforementioned respective components may operate in cooperation with each other in order to implement the operation, control or control method for the apparatuses according to various embodiments to be described below. In addition, the operation, control, and control method for the apparatuses may be implemented on the portable terminal by driving at least one application program stored in the memory 170.

The portable terminal 100 may distinguish the types of touch commands on the basis of inputs. For example, the portable terminal 100 may recognize a touch input having a magnitude smaller than a preset magnitude as a selection command onto a touched region. In addition, the portable terminal 100 may recognize a pressure touch having at least a preset magnitude as an additional command.

Hereinafter, several embodiments of the present invention will be described in detail with reference to drawings. In the description below, the “pressure touch” means a touch having a larger pressure than a critical pressure. Here, the critical pressure may appropriately be set according to applied apparatuses and application fields. For example, the critical pressure may be set to a fixed magnitude pressure, and the magnitude may be appropriately determined according to hardware characteristics, software characteristics, etc. In addition, it is also possible to configure the critical pressure to be settable by a user.

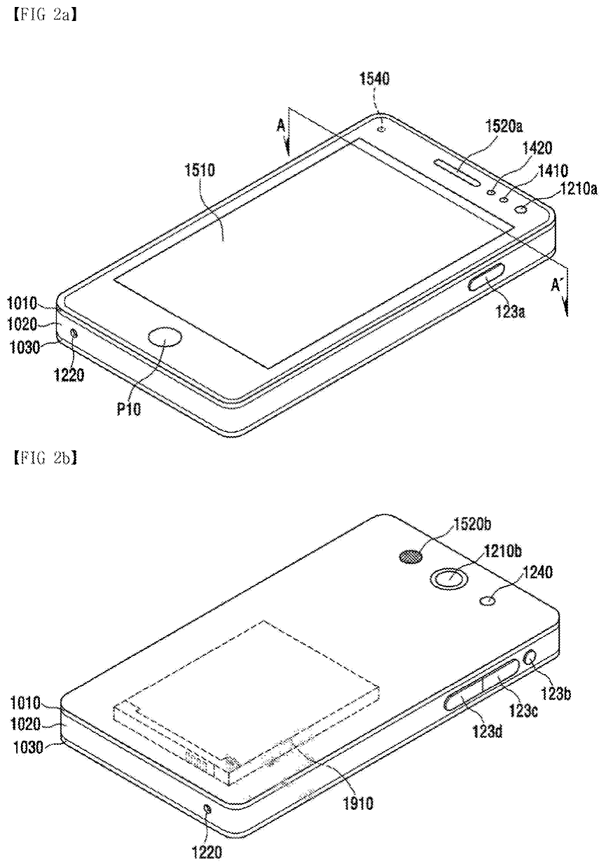

FIGS. 2a and 2b are conceptual views of a portable terminal of the present invention viewed in mutually different directions. The portable terminal according to the present invention is provided with a side operation key exposed to the outside from a side surface of the terminal.

Referring to FIGS. 2a and 2b, the portable terminal is provided with a bar-shaped terminal body, but may be applied to various structures. Here, the terminal body may be understood as the concept that views the portable terminal as at least one assembly and indicates the portable terminal.

The portable terminal includes a case (for example, a frame, a housing, a cover, etc.) that forms the external appearance thereof. As illustrated, the portable terminal may include a front surface cover 1010 and a rear case 1020. Various electronic components are disposed in the internal space formed by the coupling between the front, surface cover 1010 and the rear case 1020. At least one middle case may further be disposed between the front surface cover 1010 and the rear case 1020, and the rear case 1020 includes a side surface cover. Hereinafter, the rear case 1020 is used as a concept including the side surface cover.

A display unit 1510 is disposed on the front surface of the terminal body and may output information. As illustrated, a window 1510a of the display unit 1510 is attached to the front surface cover 1010 and may form the front surface of the terminal body together with the front surface cover 1010.

According to cases, electronic components may be attached to the rear case 1020. The components attachable to the rear case 1020 may include an attachable/detachable battery, an identification module, a memory card, etc. In this case, a rear surface cover 1030 for covering the attached electronic component may be detachably coupled to the rear case 1020. Accordingly, when the rear surface cover 1030 is detached from the rear case 1020, the electronic components attached to the rear case 1020 is exposed to the outside.

As described above, when the rear surface cover 1030 is coupled to the rear case 1020, a portion of the rear case 1020 may be exposed. According to cases, during the coupling, the rear case 1020 may also be completely covered by the rear surface cover 1030. Meanwhile, the rear surface cover 1030 may be provided with an opening for exposing a camera 1210b or a sound output unit 1520b.

These cases 1010, 1020 and 1030 may be formed by injecting a synthetic resin or also be formed of, for example, stainless steel (STS), aluminum (Al), titanium (Ti), etc.

The portable terminal may also be configured so that a single case proves the internal space unlike the above example in which a plurality of cases are provided with internal spaces for accommodating various electronic components. In this case, a unibody portable terminal may be implemented in which a synthetic resin or metal is connected from a side surface to the rear surface.

Meanwhile, the portable terminal may be provided with a waterproof unit (not shown) which prevents water from permeating into the terminal body. For example, the waterproof unit may include a waterproof member which is provided between the window 1510a and the front surface cover 1010, between the front surface cover 1010 and the rear case 1020, or between the rear case 1020 and the rear surface cover 1030, and shields the internal space during coupling thereof.

The portable terminal may be provided with: a display unit 1510, first and second sound output units 1520a and 1520b, a proximity sensor 1410, an illuminance sensor 1420, an optical output unit 1540, first and second cameras 1210a and 1210b, first to fourth manipulating units 123a to 123d, a microphone 1220, an interface unit 1600, etc. However, these configurations are not limited to these arrangements. These configurations may be excluded or replaced, or be disposed on another surface. For example, the side surfaces of the terminal body may not be provided with a second manipulating unit 123b.

The first to fourth manipulating units 123a to 123d may be referred to as manipulating keys as an example of the user input unit 1230 that is manipulated to receive commands for controlling the operations of the portable terminal. The first to fourth manipulating units 123a to 123d are switched at a connection part formed inside the rear case 1020 in such a way that physical buttons are pressed by pressurization, and transmit, to the control unit 1800, the presence of manipulations in the manipulating units. The first to fourth manipulating units 123a to 123d each have a structure in which a dome key is formed under a physical key and when the physical key is pressed, the dome key is pressed and electrically connected. For example, one among the first to fourth manipulating units 123a to 123d are used as a power key for performing a function of turning on or off the power of the terminal, one is used as a mode switching key of the terminal that switches the operation mode of the terminal between a vibration mode and a normal mode, and the remaining two may be used as volume adjustment, keys for adjusting a volume to be loud or calm. Besides, the number and the assigned functions of the manipulating units formed on the side surface may be variously changed.

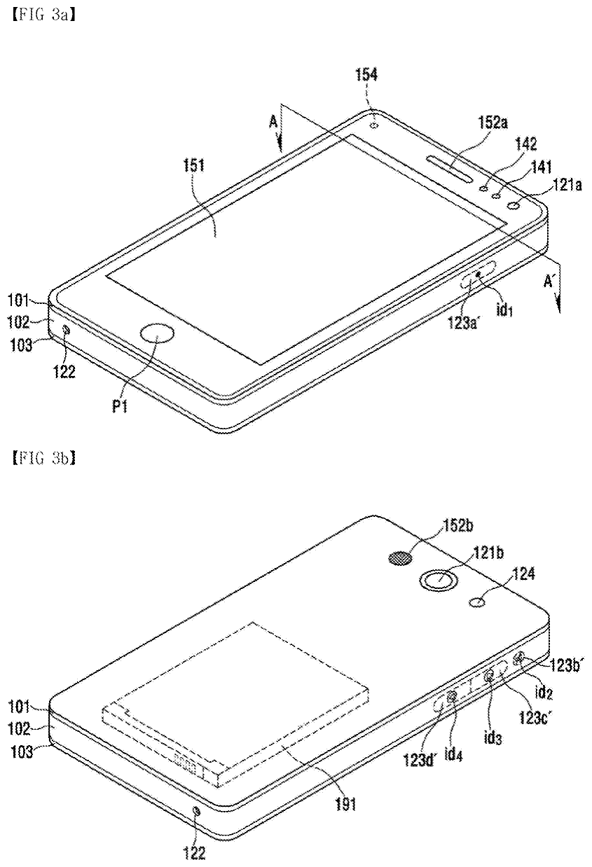

FIGS. 3a and 3b are conceptual views of a portable terminal according to an embodiment of the present invention viewed in mutually different directions.

Referring to FIGS. 3a and 3b, a portable terminal 100 according to an embodiment of the present invention has the similar configuration and function to the general portable terminal described above, and has a different configuration and an operation principle for a side surface user input unit corresponding to first to fourth manipulating units.

According to an embodiment of the present invention, side surface user input units 123a′ to 123d′ corresponding to the first to fourth manipulating units 123a to 123d, which are the side surface manipulating keys of a portable terminal according to the present invention, are formed inside the terminal body, and thus, the side surface user input units 123a′ to 123d′ may be physically formed on the outer side of the side surface cover of the terminal so as not to be exposed. The region depicted by a dotted line means a region to which the inside of the terminal body is projected. FIGS. 3a to 3b illustrate four side surface user input units 123a′ to 123d′, but various numbers of the units may be formed, and the entire side surface region may also be formed as the side surface user input unit. That is, touch keys are formed only in the region (power key region, volume adjustment key region, etc.), in which a specific function is performed, among the side surfaces of the terminal, formed in at least one region by dividing the side surface of the terminal into a plurality of regions, or formed in the entire region of the side surface of the terminal. Here, the touch keys may be configured to include at least one among a touch detection unit for detecting touch presence and touch positions and a pressure detection unit for detecting a touch pressure.

In addition, one or more indicators id1 to id4 which indicate the positions of the side surface user input units 123a′ to 123d′ may further be displayed on the outside of the side surface part of the portable terminal according to the present invention. At this point, one or more indicators id1 to id4 may be displayed by displaying characters or graphics or displaying a specific pattern by intaglio and relief. In addition, one or more indicators id1 to id4 may be formed as LEDs inside the side surface part. At this point, the side surface part may be one among the front surface cover, a middle frame, a portion extending from the rear surface cover to the side surface of the terminal, or a side surface cover.

Hereinafter, an embodiment will be described in detail in which the side surface user input units 123a′ to 123d′ are formed inside the terminal body using a cross-sectional view obtained by cutting the portable terminal 100 according to the present invention in the arrow direction with respect to line A-A′ serving as a reference line.

Hereinafter, the middle frame is used as the same meaning as the above-described rear case 102. The portable terminal may further be provided with a side surface cover 104 that surrounds the side surface of the terminal aside from the middle frame.

FIG. 4 illustrates a cross-sectional view obtained by cutting a portable terminal with respect to line A-A′ serving as a reference line, and in order to describe the structures of side surface manipulating keys 123a and 123 or side surface user input units 123a′ and 123b′, FIG. 4 is illustrated by omitting or simplifying a portion of the other configurations.

FIG. 4 is a view for describing a structure having side surface manipulating keys in the portable terminal of the present invention, and is a cross-sectional view of the portable terminal illustrated in FIG. 2a cut long line A-A′ serving as a reference line.

Referring to (a) of FIG. 4, in a portable terminal of the present invention, an insertion part (not shown) for inserting a portion of side manipulating keys 123a and 123b exposed to the outside is further formed in at least one region in the side surface of a middle frame 102, so that a portion of the side manipulating keys 123a and 123b are connected to the middle frame 102 of the terminal, and the remaining portions may be formed to be exposed to the outside.

Referring to (b) of FIG. 4, in a portable terminal of the present invention, an insertion part (not shown) for inserting a portion of side manipulating keys 123a and 123b exposed to the outside is further formed in at least one region among portions to which a rear surface cover 103 extends to a side surface of a middle frame, so that a portion of the side manipulating keys 123a and 123b are connected to the rear surface cover 103 of the terminal, and the remaining portions may be formed to be exposed to the outside.

In the portable terminal of the present invention, electrical signals may be transmitted to a control unit by pressing the side surface manipulating keys 123a and 123b exposed to the outside and bringing the keys into contact with conductor (for example, printed circuit board, FPCB, etc.) formed on the middle frame 102. The control unit may control each of the components of the terminal so as to perform functions respectively corresponding to the manipulating keys 123a and 123b when the side surface manipulating keys 123a and 123b are determined to be pressed. For example, the operation modes of the terminal may be switched between a vibration mode and a normal mode by physically forming a power key 123a, a terminal mode adjustment key 123b and the like on side surfaces of the terminal, and then pressing the power key 123a to turn the power of the terminal on or off or pressing a terminal mode adjustment key 123b. Here, the normal mode indicates one among a sound mode, a vibration mode or a soundless mode according to the operation mode of the terminal directly set by a user.

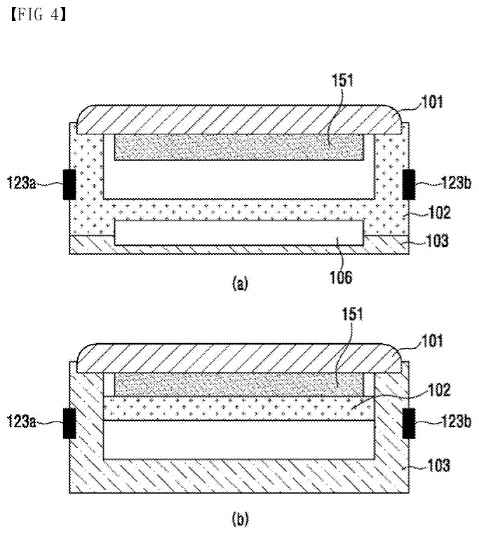

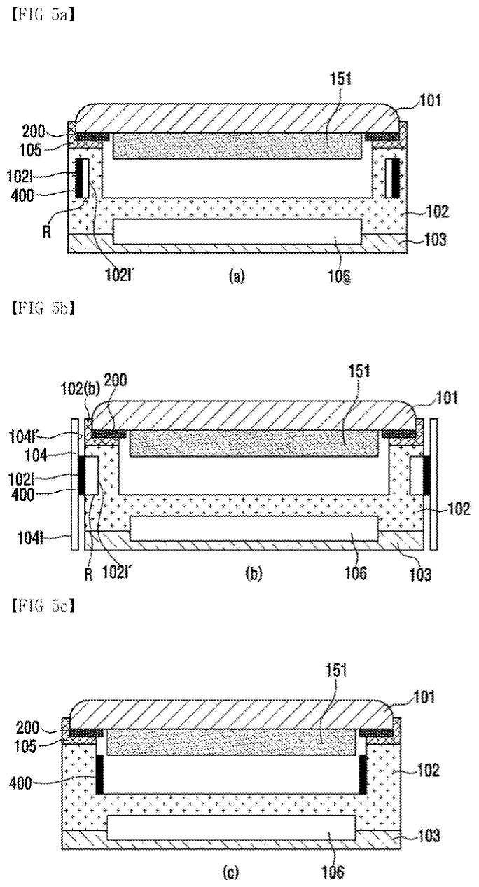

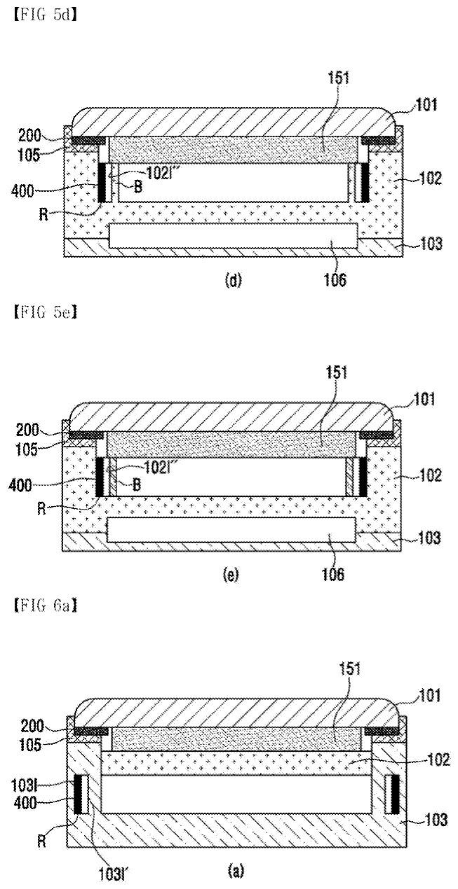

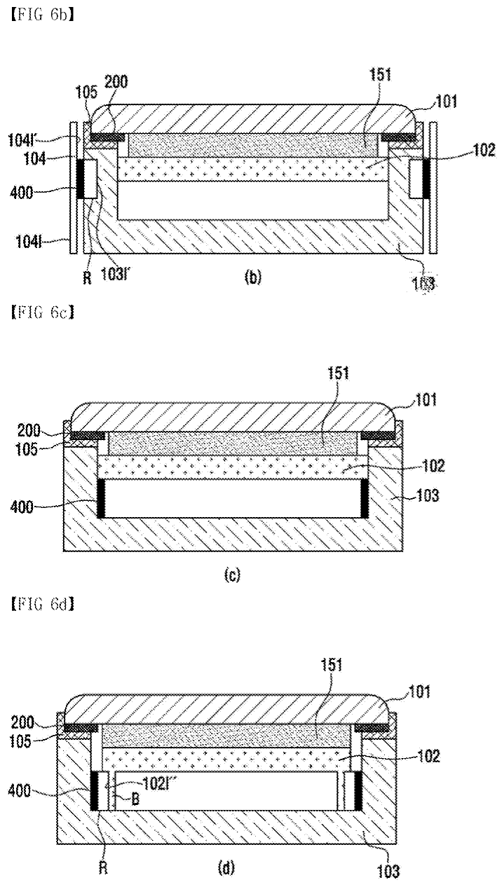

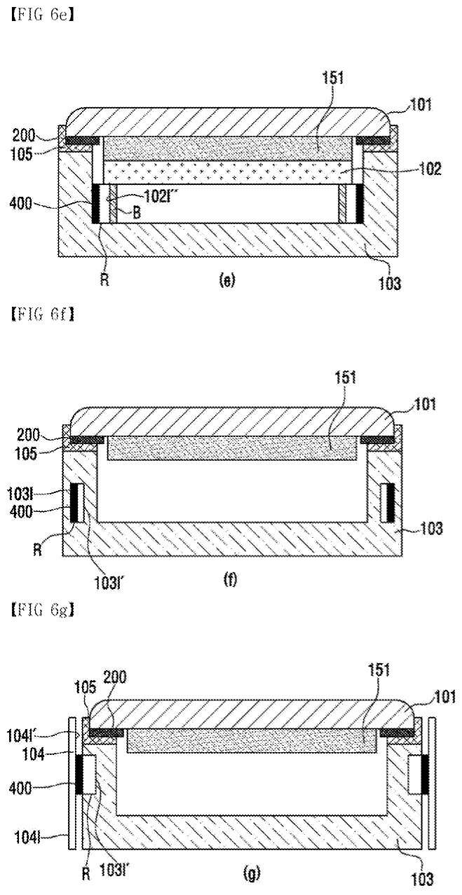

Hereinafter, with reference to FIGS. 5 and 6, an example is illustrated in which are formed an input detecting unit for detecting a side surface touch pressure of a portable terminal according to an embodiment of the present invention and a side surface touch detecting unit for detecting a side surface touch input.

A pressure detecting unit 400 according to an embodiment of the present invention detects a touch pressure applied to a side surface part of the portable terminal. The side surface part of the portable terminal may include a side surface part of a middle frame 102 as in FIG. 5 or a side surface part of a rear surface cover 103 as in FIG. 6. Accordingly, the pressure detecting unit 400 may be disposed on the side surface part of the middle frame 102 or the side surface part of the rear surface cover 103 as in FIGS. 5 and 6.

A side surface touch detecting unit according to an embodiment of the present invention detects a touch input to the side surface part of the portable terminal. The side surface touch detecting unit includes at least a portion 200 disposed on the side surface part of the portable terminal and the remainders disposed on a display unit 151. According to an embodiment, at least a portion 200 in the side surface touch detecting unit is composed of a driving electrode and the remainders disposed on the display unit 151 may be configured as a receiving electrode.

According to an embodiment, the remainders disposed on the display unit 151 may be disposed on the display unit 151 and also disposed inside the display unit 151.

Specifically, referring to FIG. 7, in a display unit 151, first driving electrodes 210 and receiving electrodes 220 may be disposed which detect touch inputs onto a front surface cover 101. In addition, the touch inputs onto the front surface cover 101 may be detected by measuring a change in mutual electrostatic capacitance between the first driving electrodes 210 and the receiving electrodes 220.

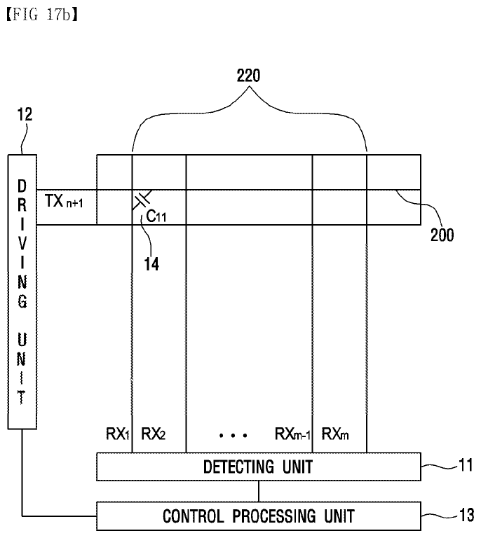

The first driving electrode 210 and the receiving electrode 220 for detecting touch inputs onto the front surface cover 101 will be described in detail in FIG. 17a.

Meanwhile, the side surface touch detecting unit for detecting touch inputs onto the side surface part of the portable terminal may include second driving electrodes which are at least a portion 200 disposed on the side surface part and receiving electrodes 220 disposed on the display unit 151. In addition, the touch inputs onto the side surface part of the portable terminal may be detected by measuring a change in the mutual electrostatic capacitance between the second driving electrode and the receiving electrode 220. At this point, a change in the mutual electrostatic capacitance may be measured by using the entirety/a portion of the receiving electrode 220. In addition, the second driving electrodes which are at least a portion 200 disposed on the side surface part may be configured by separate electrodes from the first driving electrodes 210. According to an embodiment, the second driving electrodes may be disposed on the same plane as the first driving electrodes 210, and according to another embodiment, the second driving electrodes may also be disposed on a different plane than the first driving electrodes 210.

In the present invention, a case is assumed in which at least the portion 200 disposed on the side surface part is a driving electrode, but when at least the portion 200 disposed on the side surface part according to another embodiment is configured as a receiving electrode, the touch inputs onto the side surface part of the portable terminal may also be detected by measuring a change in the mutual electrostatic capacitance between the receiving electrode and the first driving electrodes 210 disposed on the display unit 151. At this point, a change in the mutual electrostatic capacitance may also be measured by using the entirety/a portion of the first driving electrode 210. In addition, when at least the portion 200 disposed on the side surface part is configured as a receiving electrode, the receiving electrode may be configured as a different electrode than the receiving electrode 220.

Meanwhile, when the entire side surface part of a portable terminal is composed of a conductive material such as metal, and at least a portion 200 in a side surface touch detecting unit is disposed on the side surface part formed of a conductive material, the measurement of touch input may become difficult. Of course, there is a method for improving the driving voltage of the driving electrode, but in order to accurately measure the touch input, at least the portion 200 in the side surface touch detecting unit may more favorably be disposed on the side surface part formed of non-conductive material such as plastic. Accordingly, in case of the present invention, the side surface part of the portable terminal includes a first region and a second region, and as illustrated in FIGS. 5 and 6, the pressure detecting unit 400 is disposed in the first region composed of a conductive material and at least the portion 200 in the side surface touch detecting part may be disposed between the lower portion of the front surface cover 101 and the second region composed of a non-conductive material. Favorably, at least the portion 200 in the side surface touch detecting unit may be attached under the front surface cover 101. In this case, at least the portion 200 in the side surface touch detecting unit may also be disposed on the same plane as the first driving electrode 210. The first region composed of a conductive material may be implemented as the side surface part of the middle frame 102 as illustrated in FIG. 5, and as the side surface part of the rear surface cover 103 as illustrated in FIG. 6. The second region composed of a non-conductive material may also be implemented as the upper frame 105 as illustrated in FIGS. 5 and 6.

At this point, as illustrated in FIGS. 5 and 6, the pressure detecting unit 400 is disposed parallel to the side surface part of the portable terminal, and at least a portion 200 of the side surface touch detecting unit may also be disposed in a direction perpendicular to the side surface part.

FIG. 5 is a view for describing a structure which is in a portable terminal according to an embodiment of the present invention and in which: a pressure detecting unit 400 is formed in a middle frame 102; and at least a portion 200 in a side surface touch detecting unit is formed between an upper frame 105 and a front surface cover 101, and FIG. 6 is a view for describing a structure which is in a portable terminal according to an embodiment of the present invention and in which: a pressure detecting unit 400 is formed in a rear surface cover 103; and at least a portion 200 in a side surface touch detecting unit is formed between an upper frame 105 and a front surface cover 101. In other words, FIG. 5 illustrates a case in which a first region of a side surface part of the portable terminal is a side surface part of the middle frame 102, and FIG. 6 illustrates a case in which a first region of a side surface part of a portable terminal is a side surface part of the rear surface cover 103.

Schematically describing a cross-sectional surface of a portable terminal according to an embodiment of the present invention, the portable terminal is formed in a structure in which sequentially stacked are a rear surface cover 103, a component space 106, a middle frame 102, an upper frame 105, a display unit 151, and a front surface cover 101, and a mounting space for the pressure detecting unit 400 may be formed in the side surface part of the middle frame 102 or the rear surface cover 103 or in one region in the middle frame 102 or the rear surface cover 103. At this point, the mounting space may be formed inside a portion extending to a side surface of the middle frame 102 or the rear surface cover 103, or one side surface of the side surface part may foe formed as an open space, formed as a divided space on the cover side surface and a partition wall B, or formed as an arbitrary space in the cover side surface. At this point, the arbitrary space in the cover side surface defines a space which may be occupied when the pressure detecting unit is attached to the cover side surface. In the present invention, the middle frame 102 and/or the rear surface cover 103 may be implemented by using a conductive material such as metal. In addition, the upper frame 105 may be implemented by using a non-conductive material such as plastic. In the component space 106, a circuit board and/or a battery for operating the terminal may be positioned. In the present invention, the components for detecting pressure are totally referred to as the pressure detecting unit 400. For example, in an embodiment, the pressure detecting unit 400 may include pressure sensors 450 and 460.

Referring to (a) of FIG. 5, in the portable terminal according to an embodiment of the present invention, an internal mounting space R is formed in at least one region in the side surface part of the middle frame 102 and the pressure detecting unit 400 may be disposed in the internal mounting space R. The internal mounting space R of the side surface part may be formed such that the middle frame is formed as a single mold, a space corresponding to the internal mounting space R of the side surface part is then cut, or a space corresponding to the internal mounting space R is not filled when the side surface part, of the middle frame. Besides, the internal mounting space R may be formed through various methods.

At least one internal mounting space R of the middle frame 102 may be formed in at least one region in the side surface part, may be formed in the entire region of one side surface, or may be formed on the entire region of both side surfaces. In addition, the pressure detecting unit 400 is disposed in the internal mounting space R and thus is not exposed to the outside of the terminal.

The pressure detecting unit 400 is disposed parallel to the side surface of the terminal and may thus be attached to a first side surface 1021 or a second side surface 1021′ facing the first side surface 1021 of the mounting space R of the middle frame 102.

Referring to (b) of FIG. 5, in a portable terminal according to an embodiment of the present invention, a concave mounting space R which has one open side surface is formed in at least one region in the side surface part of the middle frame 102, and thus, the pressure detecting unit 400 may be disposed in the internal mounting space R. In addition, when a side surface cover 104 is coupled to a side surface of the terminal so as to cover the open one side surface of the mounting space R, the concave mounting space R is not exposed to the outside.

At least one side surface mounting space R of the middle frame 102 may be formed in at least one region in the side surface of the middle frame 102, may be formed in the entire region of one side surface, or may be formed in the entire regions of both side surfaces. In addition, when the pressure detecting unit 400 is disposed inside the mounting space R and then the side surface cover 104 is coupled thereto, the pressure detecting unit is not exposed to the outside of the terminal.

The pressure detecting unit 400 is disposed parallel to the side surface of the terminal and may thus be attached on the inner side surface 1041′ of the side surface cover 104 or the second side surface 1021′ of the mounting surface R.

Referring to (c) of FIG. 5, a portable terminal according to an embodiment may include a pressure detecting unit 400 formed on the inner side surface of a side surface part thereof. The inner side surface of the side surface part is a region not disposed to the outside, and in this case, a display unit 151 may be disposed so as to be spaced apart a predetermined distance from the inner side surface of the side surface part.

Referring to (d) of FIG. 5, a portable terminal according to an embodiment may further include a partition wall B spaced apart a predetermined distance from the inner side surface of a side surface part, and a pressure detecting unit 400 may be disposed in the mounting space R between the inner side surface of the side surface part and the partition wall B. At this point, the pressure detecting unit 400 may be attached to the inner side surface of the side surface part. Here, the partition wall B may be integrally formed with a middle frame 102. In addition, in the mounting region R, regions other than a portion in which the pressure detecting unit 400 is disposed may be configured as a free space, or also be configured to include an elastic material.

The partition wall B may be composed of a conductive material such as metal.

The pressure detecting unit 400 may be attached on the inner side surface of the side surface part or on the partition wall B, and is not exposed to the outside of the side surface part.

Referring to (e) of FIG. 5, a portable terminal according to an embodiment of the present invention has the same structure as the portable terminal of (d) of FIG. 5, but a partition wall B may be formed in a shape of a component separate from a middle frame 102.

In an embodiment of the present invention, when at least one pressure detecting unit formed in a mounting space R of a side surface part detects a touch pressure using electrostatic capacitance, a first side surface 1021, a second side surface 1021′, the inner side surface 1041′ of a side surface cover 104, the outer side surface 1041 of the side surface cover 104, the inner side surface (not shown) of a middle frame 102, or one surface 1021″ of a partition wall B may be a reference potential layer. In addition, a separate reference potential layer may further be formed inside the pressure detecting unit.

FIG. 6 illustrates an embodiment in a case in which a rear surface cover 103 extends to a side surface and constitutes a side surface part, and compared to FIG. 5, the structures of a middle frame 102 and a rear surface cover 103 are different.

Referring to (a) of FIG. 6, a portable terminal according to an embodiment of the present invention may include at least one internal mounting space R formed in at least one region in a side surface part to which a rear surface cover 103 extends to a side surface. In addition, a pressure detecting part 400 may be disposed in the internal mounting space R.

At least one internal mounting space R of the real surface cover 103 may be formed in at least one region in the side surface part of the rear surface cover 103, may be formed in the entire region of one side surface, or may be formed in the entire regions of both side surfaces. In addition, the pressure detecting unit 400 is disposed in the internal mounting space R of the rear surface cover 103 and thus is not exposed to the outside of the terminal. The internal mounting space R of the side surface part may be formed through various methods as described above according to the position and structure of the mounting space.

The pressure detecting unit 400 is disposed parallel to the side surface of the terminal and may thus be attached on a first side surface 1031 of the mounting surface R of the rear surface cover 103 or on a second side, surface 1031′ facing the first side surface 1031.

Referring to (b) of FIG. 6, in a portable terminal according to an embodiment of the present invention, a concave mounting space R may be formed in at least one region in the side surface part of a rear surface cover 103. At this point, when a side surface cover 104 is coupled to a side surface of the terminal, the concave mounting space R is not exposed to the outside.

At least one side surface mounting space R of the real surface cover 103 may be formed in at least one separate region in a portion extending to a side surface of the terminal, may be formed in the entire region of one side surface, or may be formed on the entire regions of both side surfaces. In addition, when the pressure detecting unit 400 is disposed in the mounting space R and the side surface cover 104 is coupled thereto, the pressure detecting unit is not exposed to the outside of the terminal.

The pressure detecting unit 400 is disposed parallel to a side surface of the terminal and may thus be attached on to an inner side surface 1041′ of the side surface cover 104 or a second side surface 1031′ of the mounting space R.

Referring to (c) of FIG. 6, a portable terminal according to an embodiment may include a pressure detecting unit 400 formed on the inner side surface of a side surface part of a rear surface cover 103. The inner side surface of the side surface part is a region not exposed to the outside and may be disposed on the inner side surface of the side surface part in a direction perpendicular to the lower surface of a middle frame 102 and the lower surface of the rear surface cover 103 and in a direction parallel to a side surface.

Referring to (d) of FIG. 6, a portable terminal according to an embodiment may further include a partition wall B spaced apart a predetermined distance from the inner side surface of a side surface part, and a pressure detecting unit 400 may be disposed in the mounting space R between the inner side surface of the side surface part, and the partition wall B. At this point, the pressure detecting unit 400 may be attached to the inner side surface of the side surface part.

In addition, in the mounting region R, regions other than a portion, in which the pressure detecting unit 400 is disposed, may be configured as a free space, or also be configured to include an elastic material.

The partition wall B may be composed of a conductive material such as metal.

Here, the partition wall B may be integrally formed with a middle frame 102.

In the rear surface cover, the pressure detecting unit 400 may be attached to the inner side surface (surface facing the partition wall B) of the side surface part of the rear surface cover 103, may be attached to one surface 1021″ of the partition wall B in a direction parallel to a side surface, and is not be exposed to the outside of the side surface part.

Referring to (e) of FIG. 6, a portable terminal according to an embodiment of the present invention has the same structure as the portable terminal of (d) of FIG. 6, but a partition wall B may be formed in a shape of a component separate from a middle frame 102.

In (f) to (j) of FIG. 6, embodiments in which a middle frame 102 is removed from the structures of (a) to (e) of FIG. 6 are described. For example, (f) of FIG. 6 is an embodiment in which a middle frame 102 is removed from (a) of FIG. 6, and (g) of FIG. 6 is an embodiment in which a middle frame 102 is removed from (b) of FIG. 6. At this point, as in (i) of FIG. 6, a partition wall 3 may be manufactured by being integrated with a rear surface cover 103, and as in (j) of FIG. 6, a partition wall B may also be manufactured in a form of a component separate from a rear surface cover 103.

When at least one pressure detecting unit 400, which is formed in the mounting space R of a pressure sensor side surface part, detects a touch pressure using electrostatic capacitance, a first side surface 1031 and a second side surface 1031′ in an internal mounting space R of a side surface part, the inner side surface 1041′ of a side surface cover 104, the outer side surface 1041 of the side surface cover 104, the inner side surface (not shown) of a rear surface cover 103, or one surface 1021″ of a partition wall B may be a reference potential layer. In addition, a separate reference potential layer may further be formed inside the pressure detecting unit 400.

FIGS. 5 to 6 illustrate that the pressure detecting unit 400 is formed as a touch key on the side surface part of the middle frame 102 or on the side surface part of the rear surface cover 103, but when the front surface cover 101 extends to the side surface, a touch key may be formed on a side surface part of the front surface cover and may be applied similarly to the case in which a touch key is formed on the side surface part of the rear surface cover 103.

FIG. 8 illustrates views for exemplarily describing a structure of a pressure detecting unit 400 included in a side surface part of a portable terminal according to an embodiment of the present invention.

As illustrated in FIGS. 5 to 6, the pressure detecting unit 400 may be formed on at least one side surface of an internal mounting space R of the side surface part of a middle frame 102 or a rear surface cover 103, formed on the inner side surface of the side surface part, or formed on a partition wall 5 facing the inner side surface of the side surface part.

Referring to FIG. 8, a mounting space R of a pressure detecting unit 400 included in a portable terminal according to an embodiment of may include a predetermined space S so that the distance between the pressure detecting unit 400 and a reference potential layer is changeable by a touch pressure vertically applied to a side surface of the pressure detecting unit 400 and a side surface of the terminal. In the predetermined space, an adhesive layer, a spacer layer, an air gap, an elastic form, or the like may be variously formed, and the predetermined space may be a space having a width of several ten micrometers.

The mounting space R may be configured as a single pressure detecting unit 400 so as to form a predetermined space S ((a) of FIG. 8), configured as a single pressure detecting unit 400 that does not include therein a predetermined space ((c) of FIG. 8), configured so that two pressure detecting units 400-1 and 400-2 are disposed with a predetermined space S therebetween ((d) of FIG. 8), or configured so as to include two pressure detecting units 400-1 and 400-2 ((e) of FIG. 8).

At this point, as illustrated in FIGS. 5 to 6, at least one pressure detecting unit 400 may be disposed in an internal mounting space of the side surface part of the terminal, on the inner side surface of the side surface part or a partition wall B facing the inner side surface such that the upper surface of the pressure detecting unit is parallel to the side surface of the terminal. In addition, a side surface cover may further be formed above the pressure detecting unit 400. At least one pressure detecting unit 100 is a sensor for measuring a physical quantity indicating the magnitude of a force mutually acting between two objects and may detect a change in electrostatic capacitance, a displacement of material, deformation, a change in vibration frequency, a change in thermal conductivity, and the like to determine the magnitude of pressure. The pressure sensor may be manufactured as an ultra-small type and low-power type sensor using semiconductor element manufacturing technology and micro electromechanical system (MEMS) technology. The pressure sensor may be classified according to a pressure detecting method into a piezoresistive type using a change in electrical resistance and a capacitive type using a change in electrostatic capacitance. The pressure sensor using the piezoresistive type may include a MEMS pressure sensor, a strain gauge, or a force sensing resistor, and the pressure sensor using the capacitive type may include at least one pressure electrode. At least one pressure detecting unit 400 may further detect a touch input including touch presence and touch positions. That is, at least one pressure detecting unit 400 may be formed in a structure capable of detecting only a pressure touch, or formed in a structure in which the function of a touch detecting part, which is capable of detecting not only a pressure touch, but also the touch presence and touch position of a touch input with a touch pressure smaller than a critical pressure, may be performed together. At least one pressure detecting unit 400 may be formed so as to be attached to one side surface, an inner side surface, or a partition wall B facing the inner side surface of the mounting space R in FIGS. 5 to 6 so that another side surface is freely movable due to a pressure touch.

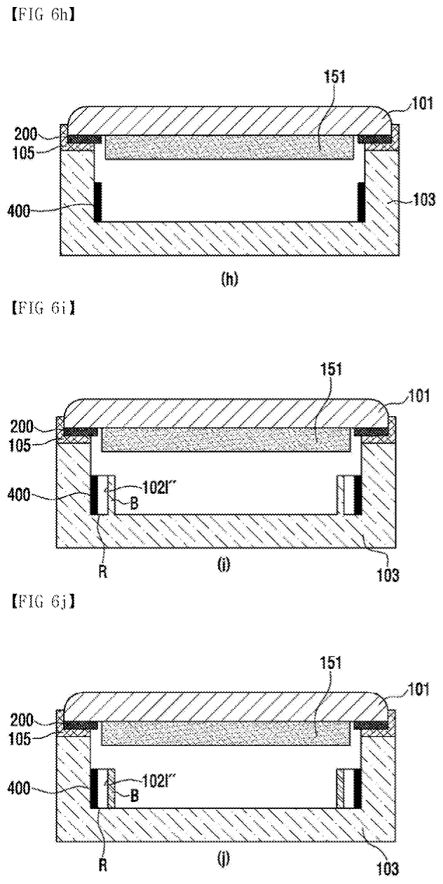

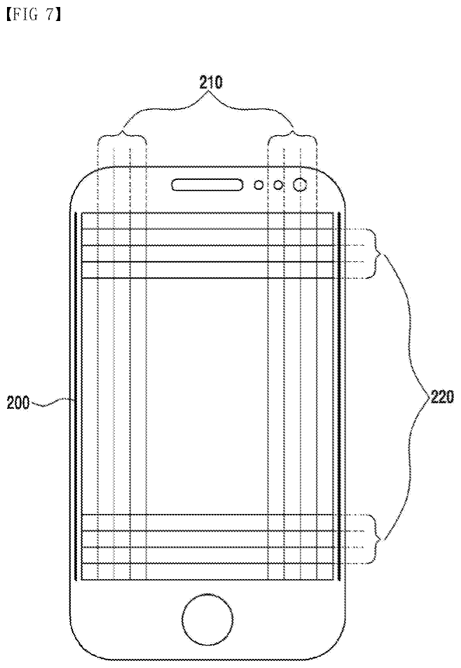

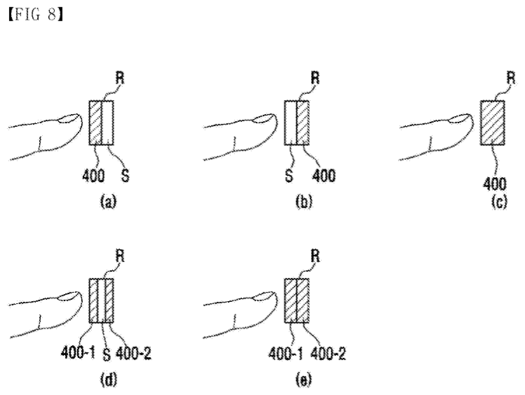

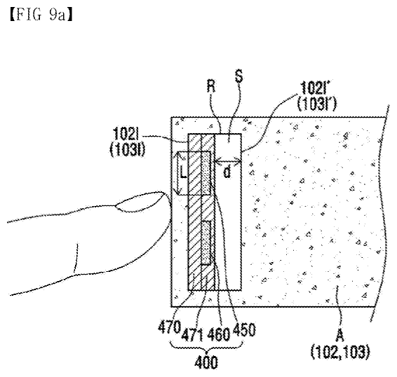

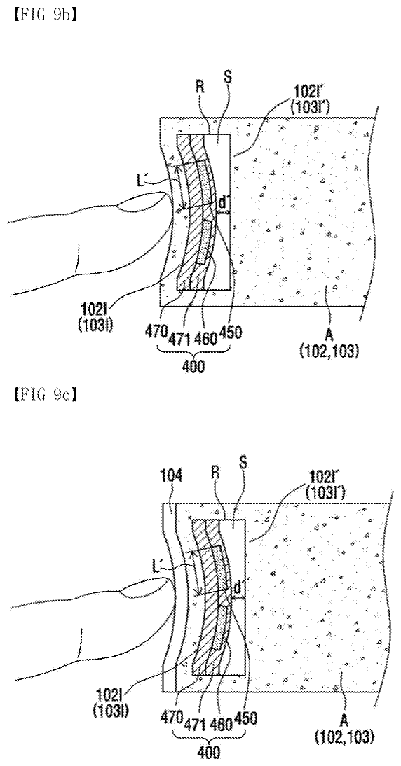

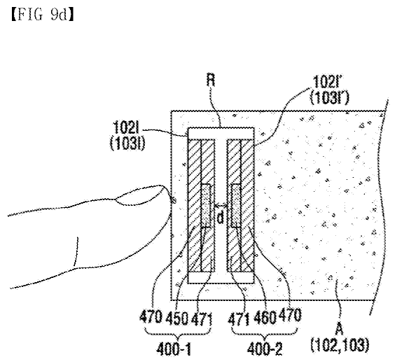

FIGS. 9a to 9d are views for describing an exemplary operation principle of a pressure detecting unit 400 included in a portable terminal according to embodiments of the present invention.

Referring to FIGS. 9a to 9d, a pressure detecting unit 400 included in a portable terminal according to an embodiment of the present invention may be formed so that one side thereof is attached to at least one side surface among first side surfaces 1021 and 1031 or second side surfaces 1021′ and 1031′ of a mounting surface R.

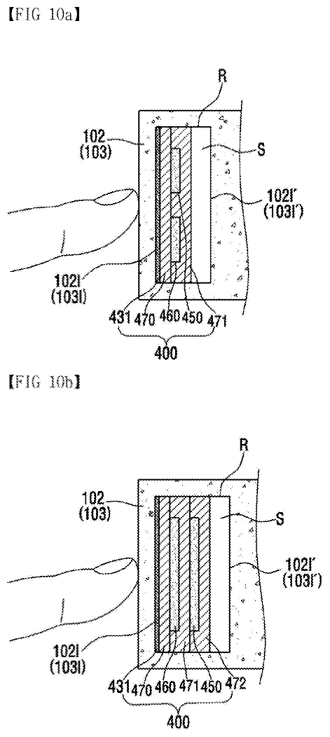

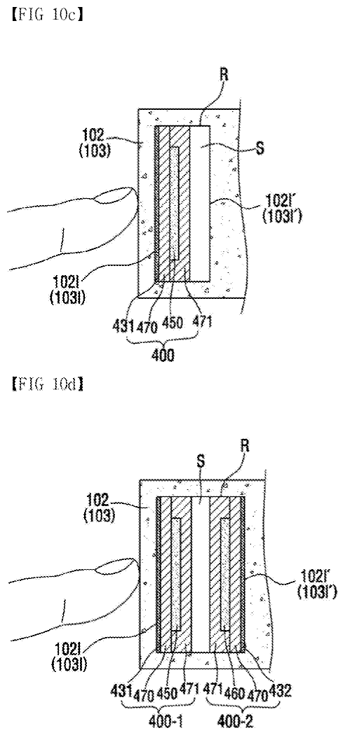

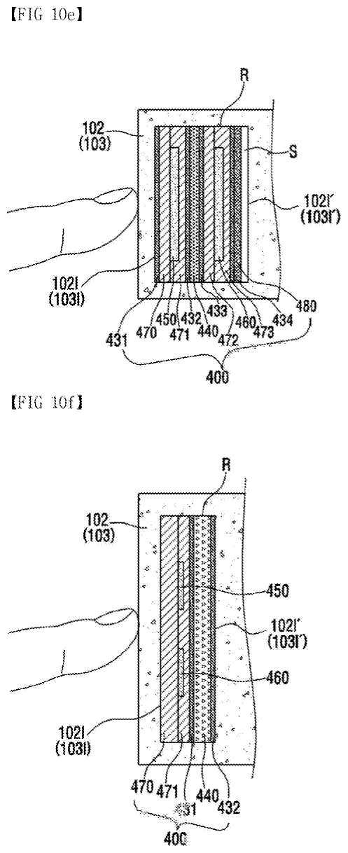

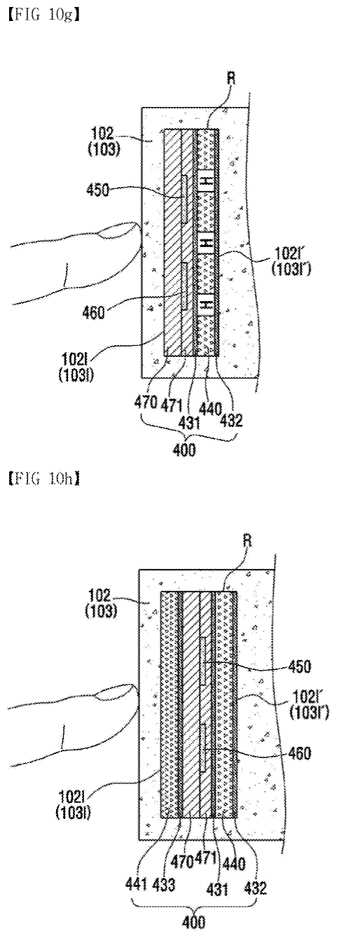

Hereinafter, a case in which a touch pressure is detected using an amount of change in electrostatic capacitance and a case in which first and second pressure sensors 450 and 460 are formed as electrodes will be exemplarily described. In FIG. 10, “A” indicates the middle frame 102 of FIG. 5 or the rear surface cover 103 of FIG. 6.

Referring to FIG. 9a, in a pressure detecting unit 400, first and second pressure sensors 450 and 460 are formed on a first insulating layer 470, and then, a second insulating layer 471 is positioned, and thus, the first and second pressure sensors 450 and 460 may be prevented from being short-circuited with a middle frame 102 or a rear surface cover 103. A mounting space may be formed so that a predetermined space S is maintained with the pressure detecting unit 400. At this point, the predetermined space S may be formed in various forms such as an air gap, a spacer layer, an elastic form, an adhesive layer, and the like and may have a width of several micrometers. One of the first pressure sensor 450 and the second pressure sensor 460 may be a driving electrode and the other may be a receiving electrode. As a driving signal is applied to the driving electrode and a pressure is applied, varying electrical characteristics may be detected through the receiving electrode. At this point, a reference potential layer (or, also referred to as “ground potential layer”) may be first side surfaces 1021 and 1031 or second side surfaces 1021′ and 1031′ in the mounting space R. For example, mutual electrostatic capacitance may be generated between the first pressure sensor 450 and the second pressure sensor 460.

Referring to FIGS. 9b and 9c, when a pressure is vertically applied to a side surface of a terminal through an object, a pressure detecting unit 400 disposed in a mounting space, a middle frame 102 or a rear surface cover 103, and a side surface cover 104 are bent and thus, the distance d between the pressure detecting unit 400 and the reference potential layer may be decreased to d′. In this case, since fringing electrostatic capacity is absorbed to a side surface of a terminal according to a decrease in distance, the mutual electrostatic capacity between the first, pressure sensor 450 and the second pressure sensor 460 may be decreased. Thus, a pressure detecting unit processor 15 or a control unit 180 may calculate a decreased amount of the mutual electrostatic capacity from the detection signal acquired through a receiving electrode to calculate the magnitude of the touch pressure. Although a case has been described in which the reference potential layer is the second side surfaces 1021′ and 1031′, when the reference potential layer is changed according to the position of the attachment surface of the pressure detecting unit 400, for example, when the reference potential layer is positioned on the first side surfaces 1021 and 1031, the inner side surface 1041′ or the outer side surface 1041 of the side surface cover 104, the magnitude of a touch pressure may be calculated by acquiring the amount of change in electrostatic capacitance due to a change in the distance between the reference potential layer and the pressure defecting unit 400.

In addition, the first pressure sensor 450 and the second pressure sensor 460 may be configured in a plurality of diamond-shaped patterns and be formed on the same layer. At this point, the plurality of first pressure sensors 450 may have a form of being mutually connected in a first axis direction, the plurality of second pressure sensors 450 may have a form of being mutually connected in a second axis direction, and at least one among the first pressure sensors 450 and the second pressure sensors 460 may have a form in which a plurality of diamond-shaped electrodes are each connected through a bridge and the first pressure sensors 450 and the second pressure sensors 460 are insulated from each other. So far, although it has been illustrated that a touch pressure is detected from a change in the mutual electrostatic capacitance between the first pressure sensors 450 and the second pressure sensors 460, any one pressure sensor among the first pressure sensors 450 and the second pressure sensors 460 may be configured to be provided only. In this case, the magnitude of the touch pressure may be detected by detecting a change in the electrostatic capacitance between the one pressure sensor (electrode) and a ground layer, that is, a change in a self electrostatic capacitance. At this point, a driving signal and a receiving signal may be applied to a single electrode and be received.

Referring to FIG. 9d, a first pressure detecting unit 400-1 and a second pressure detecting unit 400-2 may respectively be formed on first side surfaces 1021 and 1031 and second side surfaces 1021′ and 1031′ of a mounting space R. At this point, after each of the pressure detecting units 400-1 and 400-2 is formed in a sheet shape and the first pressure sensor 450 or the second pressure sensor 460 is formed on a first insulating layer 470, a second insulating layer 471 is formed and the first insulating layer 470 may be disposed on each of the first side surfaces 1021 and 1031 and the second side surfaces 1021′and 1031′.

When a pressure is applied to an outer side surface of the terminal through an object, the side surface frame of the terminal may be bent or pressed, and thus, the distance d between the first pressure detecting unit 400-1 and the second pressure detecting unit 400-2 may decrease. According to the decrease .in the distance d, the increasing amount of the mutual electrostatic capacitance between the first pressure detecting unit 400-1 and the second pressure detecting unit 400-2 may be detected, and the magnitude of a touch pressure may be calculated using this.

So far, a pressure magnitude detecting method has been described in the case in which the pressure detecting units 400 are disposed on the first side surfaces 1021 and 1031 in a mounting space and in the case in which the first pressure detecting part 400-1 and the second pressure detecting unit 400-2 are respectively formed on the first side surfaces 1021 and 1031 and the second side surfaces 1021′ and 1031′ in the mounting space, but even when the pressure detecting units 400 are disposed only on the second side surfaces 1021′ and 1031′, the pressure magnitude detecting method may be applied in the same manner.

In addition, even when the pressure detecting part 400 is formed on the side surface part of the front surface cover, touch keys may be formed in the same structure in a mounting space of the side surface part of the front surface cover.

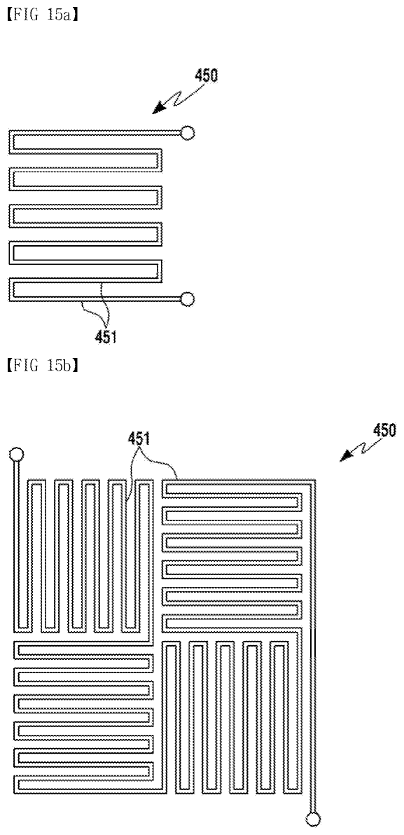

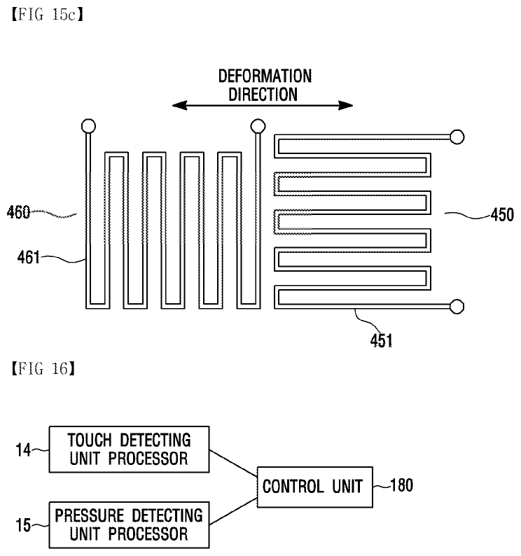

In FIG. 9a to 9d, it has been described that the pressure sensors 450 and 460 included in the pressure detecting unit 400 are configured as electrodes, and the electrostatic capacitance change amount due to bending caused by pressurization of an object with respect to the side surface part of a terminal is detected on the basis of electrical characteristics detected by the pressure detecting unit. However, embodiments are not limited thereto, and the pressure sensors 450 and 460 included in the pressure detecting unit may calculate the magnitude of a touch pressure by using, aside from the change amount of electrostatic capacitance, a change in electrical characteristics (for example, electrical resistance of a strain gauge and a quantum tunneling composite (QTC)). Specifically, in a case in which a strain gauge is used, when a pressure is perpendicularly applied to a side surface of a terminal through an object, a change in length (L->L′) of the first pressure sensor 450 and the second pressure sensor 460 is detected and the magnitude of pressure may be calculated using the change in length. In this case, a specific method will be described with reference to FIGS. 15a to 15c. In addition, in a case in which a QTC is used, when a pressure is perpendicularly applied to the side surface of the terminal through an object, the resistance value of a QTC material itself is changed due to the pressure, and the magnitude of pressure may be calculated by measuring the value of change.

Hereinafter, FIGS. 11 to 15 are for describing the structures of pressure detecting unit s400 for detecting touch pressure, and a case in which pressure sensors 450 and 460 are formed as electrodes.

FIGS. 10a to 10i are views for describing exemplary structures of pressure detecting units 400 included in portable terminals according to embodiments of the present invention.

Referring to FIG. 10a, illustrated is a cross-section in a case in which a pressure detecting unit 400 including first and second pressure sensors 450 and 460 are attached through adhesive layer 431 to first side surfaces 1021 and 1031 of a mounting space R disposed on the side surface part of a terminal so as to form a predetermined space S. At this point, in the pressure detecting unit 400, the first and second pressure sensors 450 and 460 are positioned between a first insulating layer 470 and a second insulating layer 471, and thus, the first and second pressure sensors 450 and 460 may be prevented from being short-circuited with a middle frame 102 or a rear surface cover 103. In addition, the middle frame 102 or the rear surface cover 103 may not exhibit, a ground potential or a weak ground potential. In this case, a portable terminal according to an embodiment of the present, invention may further include a ground electrode (not shown) between predetermined spaces S of the middle frame 102 or the rear surface cover 103. At this point, the ground electrode (not shown) may prevent an excessive increase in the magnitude of the electrostatic capacitance generated between the first pressure sensor 450 and the second pressure sensor 460 which constitute the pressure detecting unit 400. The first pressure sensor 450 and the second pressure sensor 460 may also be implemented on mutually different layers according to embodiments and constitute a pressure detecting unit 400.

Referring to FIG. 10b, illustrated is a cross-section in a case in which a first pressure sensor 450 and a second pressure sensor 460 are implemented on mutually different layers. As illustrated in FIG. 10b, the first pressure sensor 450 may be formed on a first insulating layer 470, and the second pressure sensor 460 may be formed on a second insulating layer 471 positioned on the first pressure sensor 450. According to embodiments, the second pressure sensor 460 may be covered with a third insulating layer 472. That is, the pressure detecting unit 400 may be configured to include the first insulating layer 470 to the third insulating layer 472, the first pressure sensor 450, and the second pressure sensor 460. At this point, the first pressure sensor 450 and the second pressure sensor 460 are positioned on mutually different layers and may thus be implemented so as to overlap each other. For example, the first pressure sensor 450 and the second pressure sensor 460 may be formed similarly to the pattern of driving electrodes TX and receiving electrodes RX which are arranged in an M×N structure. Here, M and N may be natural numbers no smaller than 1. Alternatively, the first pressure sensor 450 and the second pressure sensor 460 which have specific shapes may also be positioned on mutually different layers.

Referring to FIG. 10c, illustrated is a cross-section in a case in which a pressure detecting unit 400 is implemented including only a first pressure sensor 450. As illustrated in FIG. 10c, a pressure detecting unit 400 including a first pressure sensor 450 may be disposed on first side surfaces 1021 and 1031 in a mounting space so that a predetermined space S is formed.

Referring to FIG. 10d, illustrated is a cross-section in a case in which a first pressure detecting unit 400-1 including a first pressure sensor 450 is attached to first side surfaces 1021 and 1031 of a mounting space, and a second pressure detecting unit 400-2 including a second pressure sensor 460 is attached to second side surfaces 1021′ and 1031′ of the mounting space. At this point, a predetermined space S is formed between the first pressure detecting unit 400-1 and the second pressure detecting unit 400-2, and the first pressure detecting unit 400-1 and the second pressure detecting unit 400-2 may be respectively fixed to the first side surfaces and the second side surfaces through respective first and second adhesive layers 431 and 432.

Referring to FIG. 10e, a pressure detecting unit 400 according to an embodiment of the present invention is attached to one side surface of an internal mounting space of a side surface part by means of a first adhesive 431, and when a touch pressure is perpendicularly applied to a side surface of a terminal, the pressure detecting unit 400 is pressed and the change amount of electrostatic capacitance may be detected. At this point, a substrate 480 may be formed in the vicinity of second side surfaces 1021′ and 1031′ facing first side surfaces 1021 and 1031 on the reverse side of the first side surfaces. In addition, in the pressure detecting unit 400, an elastic form 440 is positioned between the first pressure sensor 450 and the second pressure sensor 460, so that, a change in the distance between the first pressure sensor 450 and the second pressure sensor 460 may be caused by a pressure touch. At this point, in order to attach the elastic form 440, second and third adhesives 432 and 433 may further be formed on both side surfaces of the elastic form 440. When a pressure is applied to the substrate 480, the substrate 480 may support the first and second pressure sensors 450 and 460, first, second, third, and fourth insulating layers 470, 471, 472, and 473, the elastic form 440, and the like. The second pressure sensor 460 is a ground layer and may be a reference potential layer, or a rear surface cover reference potential layer may be formed on the second side surfaces 1021′ and 1031′ of the mounting space R. When the second side surfaces 1021′ and 1031′ of a rear surface cover mounting space R is the reference potential layer, pressure may be detected by a change in the distance between the pressure detecting unit 400 and the second side surfaces 1021′ and 1031′ of the rear surface cover mounting space R in a predetermined space S.

Referring to FIG. 10f, first and second pressure sensors 450 and 460 are positioned between a first insulating layer 470 and a second insulating layer 471 in the pressure detecting unit 400 according to an embodiment of the present invention. For example, the first and second pressure sensors 450 and 460 are formed on the first insulating layer 470, and then the first and second pressure sensors 450 and 460 may be covered with the second insulating layer 471. At this point, the first insulating layer 470 and the second insulating layer 471 may be insulating materials such as polyimides. The first insulating layer 470 may be polyethylene terephthalate (PET) and the second insulating layer 471 may be a cover layer composed of an ink. The first and second pressure sensors 450 and 460 may include a material such as copper or aluminum. According to embodiments, the first insulating layer 470 and the second insulating layer 471, and the first and second pressure sensors 450 and 460 and the first insulating layer 470 may be attached by means of an adhesive (not shown) such as a liquid bond. In addition, according to embodiments, the first and second pressure sensors 450 and 460 may be formed by positioning, on the first insulating layer 470, a mask having a corresponding through-hole on a pressure electrode pattern and then spraying a conductive spray.

In FIG. 10f, a pressure detecting unit 400 may further include an elastic form 440, and the elastic form 440 may be formed as one surface of a second insulating layer 471 in the reverse direction of a first insulating layer 470 with respect to the second insulating layer 471. Subsequently, when the pressure detecting unit 400 is attached to second side surfaces 1021′ and 1031′ of a mounting space R, the elastic form 440 may be disposed on the second side surfaces 1021′ and 1031′ side.

At this point, in order to attach the pressure detecting unit 400 to the second side surfaces 1021′ and 1031′, a second adhesive layer 432 having a predetermined thickness may be formed on the outer periphery of the elastic form 440. According to embodiments, the second adhesive layer 432 may be a double-sided adhesive tape. In addition, the first adhesive layer 431 may function to attach the elastic from 440 to the second insulating layer 471. At this point, the first and second adhesive layers 431 and 432 are disposed to the outer periphery of the elastic form 440, so that the thickness of the pressure detecting unit 400 may effectively be reduced. The elastic form 440 may perform an operation corresponding to a predetermined space S. For example, when pressed from over the pressure detecting unit 400, the elastic form 440 is pressed, and the distance between the first and second pressure sensors 450 and 460 and the reference potential layer (for example, second side surface) decreases. Thus, the mutual electrostatic capacitance between the first pressure sensor 450 and the second pressure sensor 460 may be reduced. The magnitude of touch pressure may fee detected through such a change in electrostatic capacitance.

Referring to FIG. 10g, which illustrates a modified embodiment of FIG. 10f, a hole H passing through the height of an elastic form 440 is formed in the elastic form 440, so that when pressed against a pressure detecting unit 400, the elastic form 440 may be easily pressed. The hold H may be filled with air. When the elastic form 440 is easily pressed, the sensitivity of pressure detection may fee improved. In addition, the hole H is formed in the elastic form 440, so that a phenomenon may be removed in which the surface of the elastic form 440 is exposed due to air when the pressure detecting unit 400 is attached to the second side surfaces 1021′ and 1031′.

Referring to FIG. 10h, which illustrates a modified embodiment of FIG. 10h, further provided are: a first elastic form 440 on one surface of the second insulating layer 471; and a second elastic form 441 on one surface of the first insulating layer 470. Such the first elastic form 440 may further be formed in order to minimize the shock transmitted to the middle frame side of a terminal when the pressure detecting unit 400 is attached to the first elastic form. At this point, in order to attach the second elastic form 441 to the first insulating layer 470, a third adhesive layer may further be provided.

Referring to FIG. 10i, illustrated is a structure of a pressure detecting unit 400 in which first group electrodes 450 and 451 and second group electrodes 460 and 461 are disposed. The first group electrodes 450 and 451 are formed between the first insulating layer 470 and the second insulating layer 471, and the first adhesive layer 431, the elastic form 440, and the second adhesive layer 432 may be formed. The second group electrodes 460 and 461 may be formed between the third insulating layer 472 and the fourth insulating layer 473, and the fourth insulating layer 473 may be attached to one surface side of the elastic form 440. At this point, the third adhesive layer 433 may be formed on the substrate side one surface of the third insulating layer 472, and the pressure detecting unit 400 may be attached to a second side surface of a side surface mounting space of the terminal through the third adhesive layer 433. The illustrated pressure detecting unit 400 may not include the second insulating layer 471 and/or the fourth insulating layer 473. For example, the first adhesive layer 431 may function to attach the elastic form 440 to the first insulating layer 470 and the first group electrodes 450 and 451 while functioning as a cover layer that directly covers the first group electrodes 450 and 451. In addition, the second adhesive layer 432 may function to attach the elastic form 440 to the third insulating layer 472 and the second group electrodes 460 and 461 while functioning as a cover layer that directly covers the second group electrodes 460 and 461.

At this point, when the pressure detecting unit 400 is pressed, the elastic form 440 is pressed, and accordingly, the mutual electrostatic capacitance between the first group electrodes 450 and 451 and the second group electrodes 460 and 461 may increase. A touch pressure may be detected through such a change in electrostatic capacitance. In addition, according to embodiments, while any one among the first group electrodes 450 and 451 and the second group electrodes 460 and 461 serves as a ground, self electrostatic capacitance may be detected through the remaining one electrode.

In the case of FIG. 10i, the thickness and manufacturing cost of the pressure detecting unit 400 increase compared to the case in which electrodes are formed in a single layer, but pressure detection performance may be guaranteed which does not change according to the characteristics of the reference potential layer positioned outside the pressure detecting unit 400. That is, as in FIG. 9d, the pressure detecting unit 400 is formed, so that the effect due to an external potential (ground) environment may be minimized during pressure detection.

The pressure detecting unit 400 using the amount of a change in electrostatic capacitance in the present invention has a driving electrode and a receiving electrode which are divided, may detect pressure using the amount of change in mutual electrostatic capacitance that varies as the driving electrode and the receiving electrode approach the reference potential layer, and may also detect touch pressure on the basis of the amount of a change in the self electrostatic capacitance via a change in the distance from the reference potential layer while tranceiving driving and receiving signals at a single electrode. Specifically, when a pressure is applied by a touch, the reference potential layer or a pressure sensor (driving electrode or receiving electrode) move and the distance between the reference potential layer and the pressure sensor decreases, and the self electrostatic capacitance value increases. Touch pressure is detected by determining the magnitude of the touch pressure on the basis of the increased self electrostatic capacitance value. Even under the presence of user's touch, when a touch pressure is not applied, the distance between a pressure electrode and the reference potential layer does not change, and thus, the self electrostatic capacitance value does not vary. At this point, only the touch position will be detected by a touch detecting unit. However, when even a touch pressure is applied, the mutual/self electrostatic capacitance value varies in the above manner, and the pressure detecting unit 400 may detect the touch pressure on the basis of the amount of change in the self electrostatic capacitance.

In addition, even when the pressure detecting part 400 is formed on a side surface part of a front surface cover, touch keys may be formed in the same structure in a mounting space of the side surface part of the front surface cover, and a method for detecting a touch pressure may be applied in the same manner.

FIGS. 11a to 11c are views for describing other arrangement positions and structures of pressure detecting unit 400 included in portable terminals according to embodiments of the present invention. In particular, FIGS. 11a to 11c are based on the structure of the portable terminal described above in FIG. 5.

Referring to FIGS. 11a to 11c, a pressure detecting unit 400 included in a portable terminal according to an embodiment of the present invention may be attached to the inner wall of a side surface part of a middle frame 102. Here, the pressure detecting unit 400 may be configured to include at least one adhesive layer 431, 432, and 433, at least one insulating layer 470, 471 and 472, at least one electrode 450 and 460, an elastic form 440, or a substrate 480. When the inner wall of the side surface part of the middle frame 102 is formed in a shape symmetrical about the central part of the middle frame 102, the pressure detecting unit may be attached to at least one inner wall among the upper inner wall and the lower inner wall of the central part. At this point, the pressure detecting unit and the inner wall of the side surface part of the middle frame 102 may be attached by using an adhesive, an adhesive tape, or the like.

Referring to FIG. 11a, in a pressure detecting unit 400 attached to the inner wall of a side surface part of a middle frame 102, first and second pressure sensors 450 and 460 are positioned between a first insulating layer 470 and a second insulating layer 471 and a middle frame 102 and first and second pressure sensors 450 and 460 may be prevented from being short-circuited. The first and second pressure sensors 450 and 460 may operate by being divided into a driving electrode and a receiving electrode, and may respectively function as the driving electrode and the receiving electrode. Since the first and second pressure sensors 450 and 460 are formed on the same layer, a change in the distance between the side surface of the middle frame and the first and second pressure sensors 450 and 460 may be caused by the pressure perpendicularly applied to the side surface part of the middle frame. A ground layer may further be formed on the side surface part of the middle frame, and the side surface part of the middle frame may function as a reference potential layer.

Referring to FIG. 11b, in a pressure detecting unit 400 attached to the inner wall of a side surface part of a middle frame 102, a first pressure sensor 450 and a second pressure sensor 460 may be formed on mutually different layers. As illustrated in FIG. 10b, the first pressure sensor 450 is formed on a first insulating layer 470, and the second pressure sensor 460 may be formed on a second insulating layer 471 positioned on the first pressure sensor 450. According to embodiments, the second pressure sensor 460 may be covered with a third insulating layer 472. That is, the pressure detecting unit 400 may be configured to include the first insulating layer 470 to the third insulating layer 472, the first pressure sensor 450 and the second pressure sensor 460. At this point, the first pressure sensor 450 and the second pressure sensor 460 are positioned on mutually different layers and may thus be implemented so as to overlap each other. For example, the first pressure sensor 450 and the second pressure sensor 460 may be formed similarly to the pattern of driving electrodes TX and receiving electrodes RX which are arranged in an M×N structure. Here, M and N may be natural numbers no smaller than 1. Alternatively, the first pressure sensor 450 and the second pressure sensor 460 which have specific shapes may be positioned on mutually different layers.

Referring to FIG. 11c, a pressure detecting unit 400 attached to the inner wall of a side surface part of a middle frame 102 may be attached to the inner wall of the side surface part with a first adhesive 431 and detect a touch pressure perpendicularly applied to a side surface of a terminal. In addition, in the pressure detecting unit 400, an elastic form 440 is positioned between a first pressure sensor 450 and a second pressure sensor 460, so that a change in the distance between the first pressure sensor 450 and the second pressure sensor 460 may be caused by a pressure touch. At this point, in order to attach the elastic form 440, second and third adhesives 432 and 433 may further be formed on both side surfaces of the elastic form 440. The first and second pressure sensors 450 and 460 may respectively be used as a driving electrode and a receiving electrode, and in this case, a touch pressure may be detected using the amount of a change in mutual electrostatic capacitance due to a change in the distance between the first pressure sensor 450 and the second pressure sensor 460. In addition, the second pressure sensor 460 is a ground layer and may be a reference potential layer, and when a touch pressure is applied, a change in the thickness of the elastic form 440 between the first pressure sensor 450 and the second pressure sensor 460 is caused and the amount of change in electrostatic capacitance may be detected. The touch pressure may be detected using such a change in mutual/self electrostatic capacitance. In addition, when a pressure is applied to the substrate 480, the substrate 480 may support the first and second, pressure sensors 450 and 460, first, second, third, and fourth insulating layers 470, 471, 472, and 473, the elastic form 440, and the like which are stacked on the substrate 480. The substrate 480 may be disposed on a fourth adhesive 434. The second pressure sensor 460 is a ground layer and may be a reference potential layer.

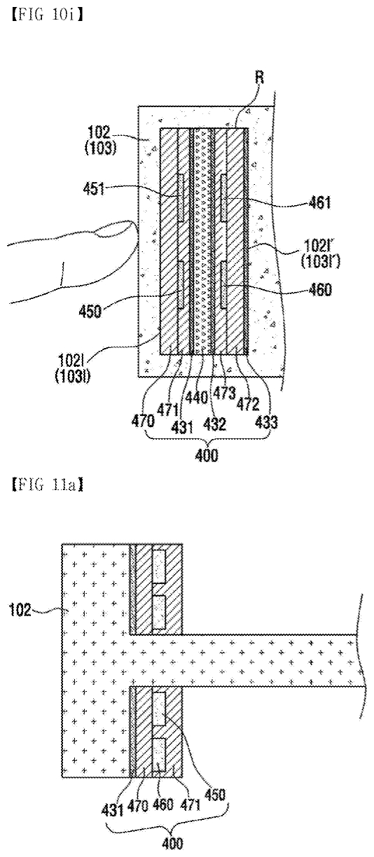

FIGS. 12a to 12c are views for describing still other arrangement positions and structures of pressure sensors included in a portable terminal according to embodiments of the present invention. In particular, FIGS. 12a to 12c are based on the structure of the portable terminal described above in FIG. 6c.

Referring to FIGS. 12a to 12c, a pressure detecting unit 400 included in a portable terminal according to an embodiment of the present invention may be attached to the inner wall of a side surface part of a rear surface cover 103. Here, the pressure detecting unit 400 may be configured to include at least one adhesive layer 431, 432, and 433, at least one insulating layer 470, 471 and 472, at least one electrode 450 and 460, an elastic form 440, and a substrate 480. The configuration and function of the pressure detecting unit 400 attached to the inner wall of the side surface part of the rear surface cover 103 are the same as those in FIG. 11a to 11c described above.

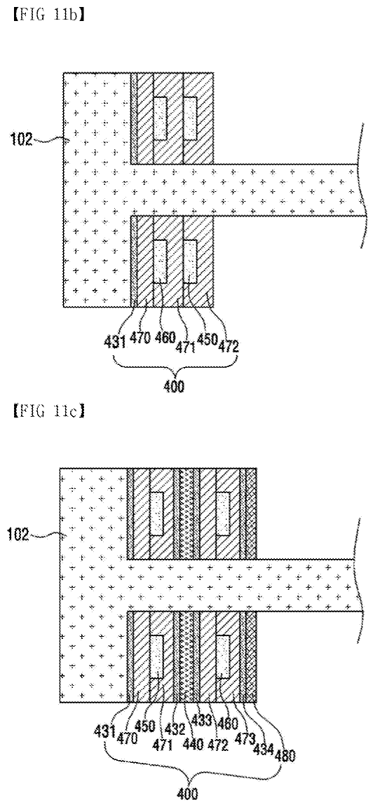

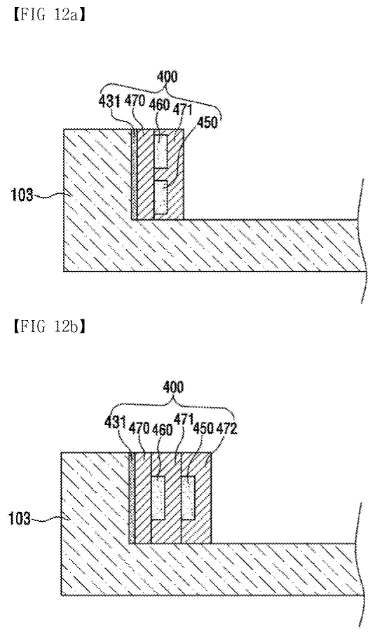

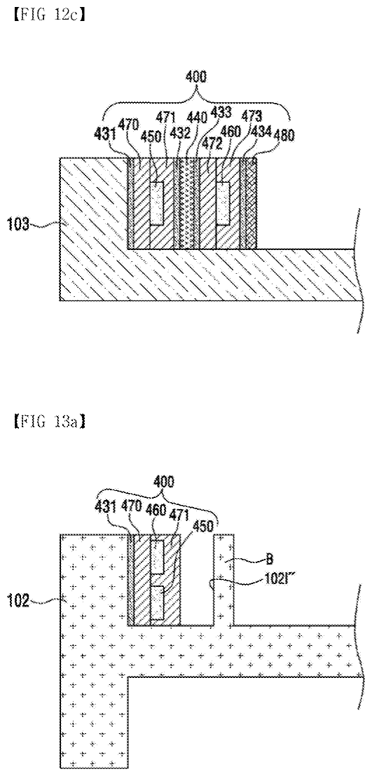

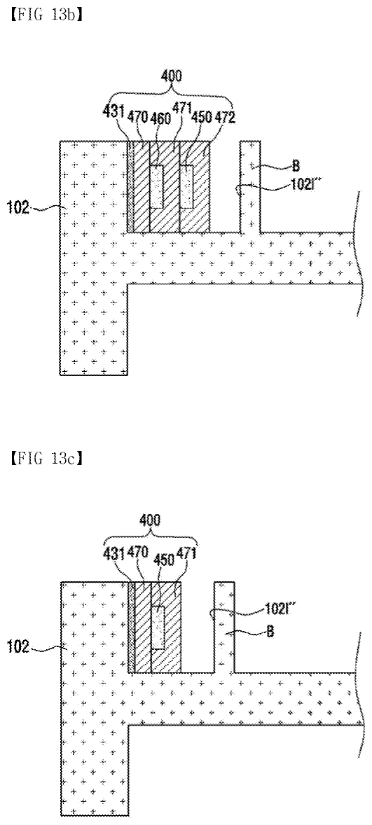

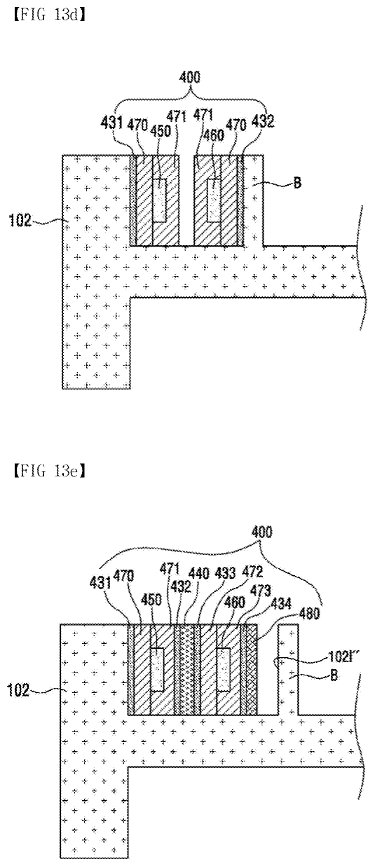

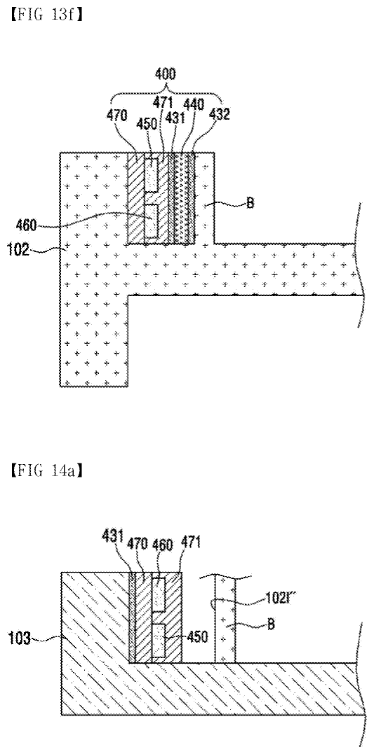

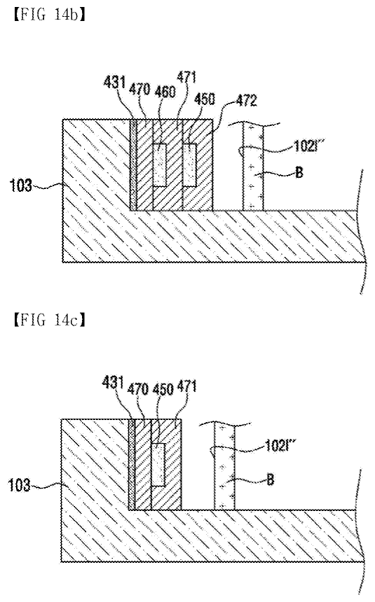

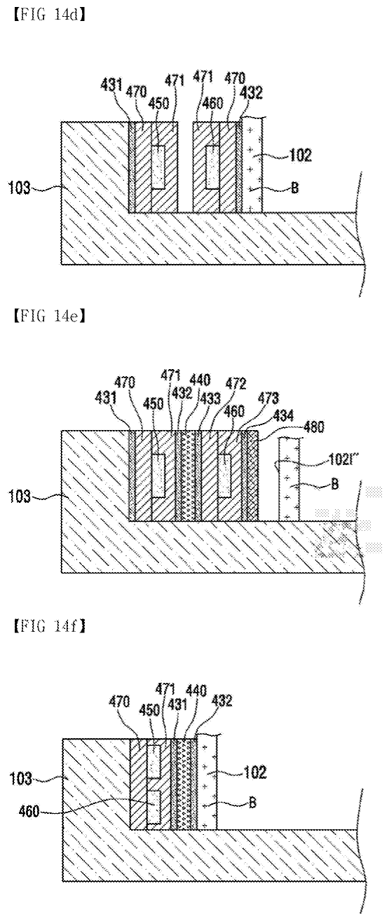

FIGS. 13a to 13f and FIGS. 14a to 14f illustrate the configurations of pressure detecting parts according to yet other embodiments of the present invention. In particular, FIGS. 13ato 13fare based on the portable terminal structures described above in FIGS. 5d to 5e. In addition, FIGS. 14ato 14fare based on the portable terminal structures described above in FIGS. 6d to 6e.

Here, a partition wall B may be integrally formed with a middle frame or a rear surface cover, and may be formed in a separate partition wall B. When the pressure detecting unit 400 is attached to the partition wall B, the pressure detecting unit may be attached to the partition wall facing the side surface part.

Referring to FIGS. 13a to 13f, a pressure detecting unit 400 attached to the inner wall of the side surface part of a middle frame or to a partition wall B may be formed in the same/similar structure as those in FIGS. 10a to 10f, and only a reference potential layer may be replaced with one surface 1021″ of the partition wall B.

Similarly, referring to FIG. 14a to 14f, a pressure detecting unit 400 attached to the inner wall of a side surface part of a rear surface cover, on which a partition wall B is formed, may be formed in the same/similar as those in FIGS. 10a to 10f, and only a reference potential layer may be replaced with one surface 1021″ of the partition wall B.

In this embodiment, the partition wall B may be formed integrally with the rear surface cover 103 or individually formed to be separated from the rear surface cover 103, and in this case, the reference potential layer may foe one surface 1021″ of the partition wall B of the rear surface cover.

FIGS. 15a to 15c are views for illustrating a case in which pressure sensors are strain gauges according to embodiments of the present invention.

When the pressure is a strain gauge 450, a touch pressure may be detected on the basis of a change in the resistance value of the strain gauge due to the touch pressure. The strain gauge is a device in which electrical resistance varies proportional to the amount of strain, and in general, a metal-coupled strain gauge may be used.

Materials usable for the strain gauge may include transparent materials such as polyethyleneioxythiophene (PEDOT), indium tin oxide (ITO), antimony tin oxide (ATO), carbon nanotubes (CNT), graphene, gallium zinc oxide, indium gallium zinc oxide (IGZO), tin oxide (SnO2), indium oxide (In2O3), zinc oxide (ZnO), gallium oxide (Ga2O3), cadmium oxide (CdO), or other doped metal oxides, and silver nanowire, platinum nanowire, nickel nanowire, and other metallic nanowires may be used for piezoresistive semiconductor materials, piezoresistive metal material, and silver nanowires. Materials usable for opaque materials may include silver ink, copper, nano silver, carbon nanotubes (CNT), constantan alloy, karma alloys, doped polycrystalline silicon, doped amorphous silicon, doped single crystal silicon, doped semiconductor material, etc.

As illustrated in FIG. 15a, a metallic strain gauge may be composed of a metallic foil arranged in a lattice type. The lattice type may maximize the deformation amount of a metallic wire or foil which may easily be deformed in parallel directions. At this point, vertical lattice cross-sections of the strain gauge 450 may be minimized in order to reduce the effects of shear strain and Poisson strain. The strain gauge 450 may include traces 451 which are not contact with each other but disposed adjacent to each other while the strain gauge is at rest, that is, is not strained or deformed in a different way. When there is no strain or force, the strain gauge may have nominal resistance, for example, approximately 1.8 KΩ±0.1%. The sensitivity to strain, which is a fundamental parameter of a strain gauge, may be expressed as a gauge factor (GF). At this point, the gauge factor may be defined as the ratio of electrical resistance change to length change (strain) and may be expressed as a following function of strain ε.

$$GF = \frac{Δ R \text{/} R}{Δ L \text{/} L} = \frac{Δ R \text{/} R}{ɛ}$$

Here, ΔR is a change amount of strain gauge resistance, R is the resistance of a undeformed strain gauge, and GF is the gauge factor.

The strain gauge 450 illustrated in FIG. 15a has high sensitivity to horizontal deformation because a trace 451 is arranged in the horizontal direction and has a large length change of the trace 451 with respect to the horizontal deformation, but the trace has low sensitivity to vertical deformation because the trace 451 has relatively small length change with respect to vertical deformation.

Referring to FIG. 15b, a strain gauge 450 may include a plurality of detailed regions and the arrangement direction of the traces 451 included in each detailed region may be differently configured. As such, differences in the sensitivity of the strain gauge 450 with respect to deformation directions may be reduced by providing the strain gauge 450 including the traces 451 having different arrangement directions.

Referring to FIG. 15c, the deformation directions of the traces 451 and 461 with respect to applied pressure may vary according to the arrangement directions of the strain gauges 450 and 460. Thus, the strain gauges 450 and 460 may be disposed so that the lengthwise directions of the traces 451 and 461 are arranged according to the direction in which pressure is applied.

An increase in temperature may expand the frame even without applied pressure, and consequently, the strain gauge 450 may be stretched, and thus, a change in temperature may exert an adverse influence on the strain gauge 450. When the temperature rises, the resistance of the strain gauge 450 increases and may be incorrectly interpreted as a pressure applied to the strain gauge 430. In order to compensate a change in temperature, two gauges may be used to minimize the influence of the change in temperature. For example, when a horizontal deformation occurs, traces 451 of the strain gauge 450 may be arranged in a horizontal direction parallel to the deformation direction, and traces 461 of a dummy strain gauge 460 may be arranged perpendicular to the deformation direction and arranged in the vertical direction. At this point, the deformation affects the strain gauge 450 and do not almost affect the dummy strain gauge 460, but since temperatures exert the same influence on both the strain gauge 450 and the dummy strain gauge 460, the change, due to temperatures may be removed and only the value due to pressure change may be detected.

A portable terminal according to the present invention may be provided with a pressure sensor configured having a single channel by forming a single strain gauge 450. In addition, a portable terminal according to the present invention may be provided with a pressure sensor configured having a plurality of channels by forming a plurality of strain gauges 450. Such the pressure sensor configured having a plurality of channels may be used to simultaneously sense the magnitudes of the plurality of pressures with respect to a plurality of touches.

Besides, at least one pressure sensor may be composed of a piezoelectric element. When mechanical stress (specifically, mechanical force or pressure) is applied to a specific solid material and a deformation occurs, electric charges are accumulated while polarization is generated inside the specific solid. The collected electric charges appear as a form of an electrical signal, that is, a voltage, between both electrodes of the material. This phenomenon is referred to as a piezoelectric effect, the solid material is referred to as a piezoelectric material, and the collected charges are referred to as piezoelectricity. At least one pressure sensor may detect electrical energy (force or pressure) applied to the piezoelectric element and electrical energy (voltage which is a type of electrical signal) generated by deformation due to the applied energy, and a control unit may calculate the applied mechanical force or pressure on the basis of the detected voltage.

In addition, at least one pressure sensor may be implemented as a MEMS pressure sensor. The MEMS pressure sensor is manufactured by rear surface penetration etching of a semiconductor substrate (frame of side surface part) according to a used pressure range and be used as an absolute pressure or a differential pressure sensor. MEMS pressure sensors may be classified into a pressure resistance type and a capacitive type according to pressure detecting methods and classified into a bulk type and a surface type according to manufacturing methods. The pressure resistance type pressure sensor may measure a pressure magnitude by forming a thin film through a semiconductor process, forming a pressure resistive body on the boundary between the thin film and a substrate, and detecting that when a thin film is deformed due to pressure, the resistance of pressure resistive body varies, and the capacitive type ME MS pressure sensor may measure a pressure magnitude by detecting a change amount of electrostatic capacitance between electrodes due to a change in the distance between electrode plates facing each other, the change being caused by external force (stress). The bulk-type MEMS pressure sensor may be manufactured by a method in which a detecting circuit is formed on the front surface of a silicon substrate, and the substrate is processed by penetrating the substrate from the rear surface of the substrate to use the upper portion of the substrate as a detecting thin film, and the surface-type MEMS pressure sensor may be manufactured by a method in which a substrate is not directly processed and a detecting thin film and a pressure cavity are formed on the surface of the substrate through a semiconductor process.

As such, at least one pressure sensor is diversified, and embodiments of the present invention are not limited to a specific pressure detecting element, and any method may be applied as long as the pressure at a touch position may be acquired directly or indirectly.

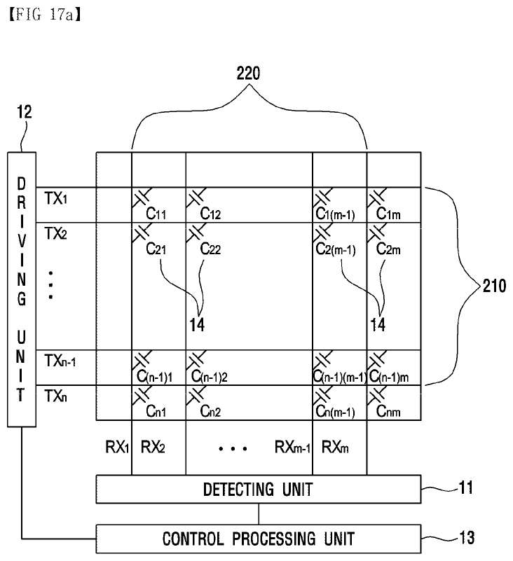

FIG. 16 illustrates a control block for controlling a touch position, a touch pressure and function execution corresponding thereto in a portable terminal according to an embodiment of the present invention.

Referring to FIG. 16, a touch detecting unit and a pressure detecting unit 400 may be configured to be respectively provided with individual processors 14 and 15 and transmit a touch position or a touch pressure to a control unit 180, and also be configured to simply transmit, to the control unit, a detected signal (for example, self electrostatic capacitance, mutual electrostatic capacitance, strain gauge change amount, etc.). The control unit 180 may be an application processor (AP) or a central processing unit (CPU) of the portable terminal. In addition, a touch detecting unit processor 14 may control a front surface touch detecting unit for detecting a touch position with respect to a front surface cover 101 and/or a side surface touch detecting unit for detecting a touch position with respect to a side surface part of the portable terminal.

Specifically, the touch detecting unit processor 14 and a pressure detecting unit processor 15 may respectively be formed as separate ICs, or may simultaneously perform respective functions on a single IC. That is, in the portable terminal including the touch detecting unit processor 14 and the pressure detecting unit processor 15, detection of touch presence and touch position may be performed by the touch detecting unit processor 14, and determination of pressure magnitude calculation and pressure touch may be performed by the pressure detecting unit processor 15. In addition, although the touch detecting unit processor 14 and the pressure detecting unit processor 15 are provided, the touch detecting unit processor 14 and the pressure detecting unit processor 15 only transmit, to the control unit 180, a detected signal (for example, self electrostatic capacitance, mutual electrostatic capacitance, strain gauge change amount etc.), and the control unit 180 may process touch presence, touch position detection, pressure magnitude calculation and pressure touch determination, functions corresponding thereto, etc.

FIG. 17a is schematic view of a capacitive-type front surface touch detecting unit, and FIG. 17b is a schematic view of a capacitive-type side surface touch detecting unit.

Referring to FIG. 17a, the capacitive-type front surface touch detecting unit included in a portable terminal according to an embodiment of the present invention includes a plurality of driving electrodes TX1 to TXn (corresponding to 210 of FIG. 7) and a plurality of receiving electrodes RX1 to RXm (corresponding to 220 of FIG. 7). The front surface touch detecting unit, may be connected to: a driving unit 12 which applies a driving signal to the plurality of driving electrodes TX1 to TXn for the operation of the front surface touch defecting unit; a detecting unit 11 which detects a detection signal including information about the change amount of electrostatic capacitance varying according to a touch onto a touch surface of a front surface cover 101; and a control processing unit 13 which applies a control signal to the driving unit 12 and determines touch presence and touch positions from detection signals received from the detecting unit 11. Here, the control processing unit 13 may be one among the touch detecting unit processor 14 or the control unit 180 which are described above.

FIG. 17a illustrates that the plurality of driving electrodes TX1 to TXn and the plurality of receiving electrodes RX1 to RXm constitute an orthogonal array,

The plurality of driving electrodes TX1 to TXn and the plurality of receiving electrodes RX1 to RXm may be arranged so as to cross each ether. The driving electrodes TX may include a plurality of driving electrodes TX1 to TXn extending in the first axis direction and a plurality of receiving electrodes RX1 to RXm extending in the second axis direction crossing the first axis direction. At this point, when the driving electrodes TX are formed in the row direction, the receiving electrodes RX are formed in the column direction crossing the driving electrodes TX. In addition, when the driving electrodes TX are formed in the column direction, the receiving electrodes RX are formed in the row direction crossing the driving electrodes TX.

The plurality of driving electrodes TX1 to TXn and the plurality of receiving electrodes RX1 to RXm may be arranged on mutually different layers. For example, the plurality of driving electrodes TX1 to TXn and the plurality of receiving electrodes RX1 to RXm may be formed on each of both surfaces of a single insulating film (not shown), or the plurality of driving electrodes TX1 to TXn may be formed on one surface of a first insulating film (not shown), and the plurality of receiving electrodes; RX1 to RXm may be formed on one surface of a second insulating film (not shown) different from the first insulating film.

The plurality of driving electrodes TX1 to TXn and the plurality of receiving electrodes RX1 to RXm may be composed of a transparent conductive material (for example, indium tin oxide (ITO) composed of tin oxide (SnO2), indium oxide (In2O3) or the like, antimony tin oxide (ATO), or the like). However, this is merely an example, and the driving electrodes TX and the receiving electrodes RX may also be composed of different transparent conductive material or an opaque conductive material. For example, the driving electrodes TX and the receiving electrodes RX may be formed by including at least any one among silver ink, copper, or carbon nanotubes (CNT). In addition, the driving electrodes TX and the receiving electrodes RX may be implemented as metal meshes or composed of a nano silver material.

The driving unit 12 may apply driving signals to the driving electrodes TX1 to TXn, and the driving signals may be sequentially applied once to a single driving electrode from the first driving electrode TX1 to the nth driving electrode TXn. The application of these driving signals may repeatedly be performed. This is merely an example, and according to embodiments, driving signals may simultaneously be applied to the plurality of driving electrodes TX1 to TXn.

The detecting unit 11 receives detection signals including information about electrostatic capacitance Cnm 14 generated between the driving electrodes TX1 to TXn and the receiving electrodes RX1 to RXm to which driving signals are applied through the receiving electrodes RX1 to RXm. For example, the detection signals applied to the driving electrodes TX may be signals coupled by the electrostatic capacitance Cnm 14 generated between the driving electrodes TX and the receiving electrodes RX. As such, the process for detecting the driving signals applied to the first, driving electrode TX1 to the nth driving electrode TXn through the receiving electrodes RX1 to RXm may be said to scan the front surface touch detecting unit.

For example, the detecting unit 11 may be configured to include receivers (not shown) connected to the respective receiving electrodes RX1 to RXm through a switch. The switch is turned on in a time interval for detecting a signal of the corresponding receiving electrode RX and causes the signal from the receiving electrode RX to be detected by the receiver. The receiver may be configured to include an amplifier (not shown) and a feedback capacitor coupled between the negative (−) input terminal and the output terminal of the amplifier. At this point, the positive (+) input terminal of the amplifier may be connected to a ground. In addition, the receiver may further include a rest switch connected in parallel to the feedback capacitor. The reset switch may reset the conversion from current into voltage performed by the receiver. The negative input terminal of the amplifier may be connected to the corresponding receiving electrode RX and covert, to a voltage, a current signal including information about the electrostatic capacitance Cnm 101 by receiving and integrating the current signal. The detecting unit 10 may further include an analog to digital converter (ADC) that converts the data integrated through the receiver. Subsequently, the digital data may be input to the control processing unit 13 and processed so that touch information about the front surface touch detecting unit is acquired. The detecting unit 11 may be integrally formed with the receiver by including the ADC and the control processing unit 13.

The control processing unit 13 may perform a function for controlling the operation of the driving unit 12 and the detecting unit 11. For example, the control processing unit 13 generates a drive control signal, transmits the signal to the driving unit 12, and then may allow the driving signal to be applied to the preset driving electrode TX at a predetermined time. In addition, the control processing unit 13 generates a detection control signal, transmits the signal to the detecting unit 11, and may allow the detection signal from the preset receiving electrode RX to be received and allow a preset function to be performed.

Referring to FIG. 17b, a side surface touch detecting unit according to an embodiment of the present invention may be formed to include only a single driving electrode TXn+1 (corresponding to 200 of FIG. 7) which is at least a portion 200 of the side surface touch detecting unit and a plurality of receiving electrodes RX1 to RXm (corresponding to 220 of FIG. 7), that is, may be formed in a single row. Alternatively, according to another embodiment, when at least a portion 200 among the side surface touch detecting unit is a receiving electrode, a single receiving electrode RXn+1 and a plurality of driving electrodes TX1 to TXn (corresponding to 210 of FIG. 7) may be configured to be included in the side surface touch detection unit.

When the side surface touch detecting unit includes a single driving electrode TXn+1 (corresponding to 200 of FIG. 7), which is at least a portion 200 among the side surface touch detecting unit, and a plurality of receiving electrodes RX1 to RXm (corresponding to 220 of FIG. 7), a touch position may be determined toy the receiving electrode that receives a touch position as a signal, that is, by only an x-coordinate. Conversely, when the side surface touch detection unit includes a single receiving electrode RXn+1, which is at least a portion 200 among the side surface, touch detecting unit, and a plurality of driving electrodes TX1 to TXn (corresponding to 210 of FIG. 7), a touch position may be determined by the driving electrode to which a signal is applied, that is, by only a y-coordinate.

In FIGS. 17a to 17b, the driving unit 12 and the detecting unit 11 may constitute a touch detecting apparatus (not shown) which is capable of detecting the touch presence and touch positions with respect to a side surface touch detecting unit according to an embodiment of the present invention. The touch detecting apparatus according to an embodiment of the present invention may further include a control processing unit 13. The touch detecting apparatus according to an embodiment of the present invention may be implemented by being integrated on a touch sensing integrated circuit (IC) which is a touch sensing circuit. Driving electrodes TX and receiving electrodes RX included in the side surface detecting unit may be connected to a driving unit 12 and a detecting unit 11 which are included in a touch sensing IC (not shown) via a conductive pattern printed on, for example, a conductive trace and/or circuit board. The touch sensing IC may be positioned on a circuit board on which a conductive pattern is printed, for example, on a first printed circuit board (hereinafter, referred to as first PCB). According to embodiments, the touch sensing IC may be mounted on a main board for operation of a touch input apparatus.

As described so far, electrostatic capacitance of a predetermined value is generated for each of the intersection points between the driving electrodes TX and the receiving electrodes, and when an object such as a finger, palm, or stylus approaches the side surface part of the portable terminal, the value of the electrostatic capacitance may vary The electrostatic capacitance may exhibit mutual electrostatic capacitance Cnm. The detecting unit 11 detects such electrical characteristics and may detect the touch presence and/or touch position with respect to the side surface detecting unit.

### INDUSTRIAL APPLICABILITY

According to a portable terminal of an embodiment, implemented are not a front surface touch sensor and a front surface pressure sensor, but a separate side surface touch sensor and a separate side surface pressure sensor, and thus, the touch position and the touch pressure which are applied to a side surface of the portable terminal may be detected.

In addition, when the frame of a portable terminal is implemented overall using a metallic material, a side surface touch sensor provided to a side surface of the portable terminal is configured to be disposed on a non-metallic material portion, and thus, the touch position detecting sensitivity with respect to the side surface may be improved.

1. A portable terminal comprising:
a front surface cover;
a pressure detecting unit disposed on a side surface part of the portable terminal and configured to detect a touch pressure applied to the side surface part; and
a side surface touch detecting unit configured to detect a touch input to the side surface part of the portable terminal, wherein:
the side surface part comprises a first region and a second region separate from the first region;
the pressure detecting unit is disposed in the first region of the side surface part; and
at least a portion of the side surface touch detecting unit is disposed between a lower portion of the front surface cover and the second region.

2. The portable terminal of claim 1, wherein the first region is composed of a conductive material and the second region is composed of a non-conductive material.

3. The portable terminal of claim 1, wherein the pressure detecting unit is disposed parallel to the side surface part, and at least a portion of the side surface touch detecting unit is disposed in a direction orthogonal to the side surface part.

4. The portable terminal of claim 1, further comprising a display unit disposed under the front surface cover, wherein:
a first driving electrode and a receiving electrode which detect a touch pressure against the front surface cover are disposed on the display unit;
at least a portion of the side surface touch detecting unit comprises a separate second driving electrode different from the first driving electrode;
the remainder of the side surface touch detecting part comprises the receiving electrode; and
a touch input to the side surface part of the portable terminal is detected by a change in mutual electrostatic capacitance between the second driving electrode and the receiving electrode.

5. The portable terminal of claim 4, wherein the second driving electrode is attached to a lower portion of the front surface cover.

6. The portable terminal of claim 4, wherein the first driving electrode and the second driving electrode are disposed on a same plane.

7. The portable terminal of claim 1, wherein:
the first region of the side surface part is a side surface part of a middle frame of the portable terminal; and
the pressure detecting unit is disposed in a mounting space of the side surface part of the middle frame or on an inner side surface of the side surface part of the middle frame.

8. The portable terminal of claim 1, wherein:
the first region of the side surface part is a side surface part of a rear surface cover of the portable terminal; and
the pressure detecting unit is disposed in a mounting space of the side surface part of the rear surface cover or on an inner side surface of the side surface part of the rear surface cover.

9. The portable terminal of claim 7, wherein:
a first side surface, a second side surface facing the first side surface, or the inner side surface which is in the mounting space is a reference potential layer, and
the touch pressure is detected by a change in electrostatic capacitance due to a change in a distance between the pressure detecting unit and the reference potential layer.

10. The portable terminal of claim 7, further comprising a side surface cover configured to cover the mounting surface.
